(19) United States
(12) Patent Application Publication
(10) Pub. No.: US 2006/0078802 A1
(43) Pub. Date: Apr. 13, 2006

(54) Holographic storage medium

(76) Inventors: Kwok Pong Chan, Troy, NY (US); Brian Lee Lawrence, Clifton Park, NY (US); Eugene Pauling Boden, Scotia, NY (US)

Correspondence Address: GENERAL ELECTRIC COMPANY;GLOBAL RESEARCH, PATENT DOCKET RM. BLDG. K1-4A59, NISKAYUNA, NY, 12309, US

(21) Appl. No.: 10/964,092

(22) Filed: Oct. 13, 2004

(51) Int. Cl. G03H 1/04

(52) U.S. Cl. 430/1; 430/2; 359/3

(57) ABSTRACT

Disclosed herein is a method of manufacturing a data storage media comprising mixing a photoactive material, a photosensitizer and an organic binder material to form a holographic composition, wherein the photoactive material undergoes a change in color upon reaction with the photosensitizer; and molding the holographic composition into holographic data storage media. Disclosed herein too is a method for recording information comprising irradiating an article that comprises a photoactive material; a photosensitizer and an organic polymer, wherein the irridation is conducted with electromagnetic energy having a wavelength of about 350 to about 1,100 nanometers, wherein the photoactive material can undergo a change in color upon reaction with the photosensitizer; and reacting the photoactive material to record data in holographic form.

### BACKGROUND

The present disclosure relates to optical data storage media, and more particularly, to holographic storage mediums as well as methods of making and using the same.

Holographic storage is data storage in which the data is represented as holograms, which are images of three dimensional interference patterns created by the intersection of two beams of light, in a photosensitive medium. The superposition of a reference beam and a signal beam, containing digitally encoded data, forms an interference pattern within the volume of the medium resulting in a chemical reaction that changes or modulates the refractive index of the medium. This modulation serves to record as the hologram both the intensity and phase information from the signal. The hologram can later be retrieved by exposing the storage medium to the reference beam alone, which interacts with the stored holographic data to generate a reconstructed signal beam proportional to the initial signal beam used to store the holographic image.

Each hologram may contain anywhere from one to 1×10⁶ or more bits of data. One distinct advantage of holographic storage over surface-based storage formats, including CDs or DVDs, is that a large number of holograms may be stored in an overlapping manner in the same volume of the photosensitive medium using a multiplexing technique, such as by varying the signal and/or reference beam angle, wavelength, or medium position. However, a major impediment towards the realization of holographic storage as a viable technique has been the development of a reliable and economically feasible storage medium.

Early holographic storage media employed inorganic photorefractive crystals, such as doped or undoped lithium niobate (LiNbO₃), in which incident light creates refractive index changes. These index changes are due to the photo-induced creation and subsequent trapping of electrons leading to an induced internal electric field that ultimately modifies the index through a linear electro-optic effect. However, LiNbO₃ is expensive, exhibits relatively poor efficiency, and requires thick crystals to observe any significant index changes.

More recent work has led to the development of polymers that can sustain larger refractive index changes owing to optically induced polymerization processes. These materials, which are referred to as photopolymers, have significantly improved optical sensitivity and efficiency relative to LiNbO₃ and its variants. In prior art processes, “single-chemistry” systems have been employed, wherein the media comprise a homogeneous mixture of at least one photoactive polymerizable liquid monomer or oligomer, an initiator, an inert polymeric filler, and optionally a sensitizer. Since it initially has a large fraction of the mixture in monomeric or oligomeric form, the medium may have a gel-like consistency that necessitates an ultraviolet (UV) curing step to provide form and stability. Unfortunately, the UV curing step may consume a large portion of the photoactive monomer or oligomer, leaving significantly less photoactive monomer or oligomer available for data storage. Furthermore, even under highly controlled curing conditions, the UV curing step may often result in variable degrees of polymerization and, consequently, poor uniformity among media samples.

Thus, there remains a need for improved polymer systems suitable for holographic data storage media. In particular it would be advantageous for the data storage media to be written and read at the same wavelength without any degradation of the stored data.

### SUMMARY

Disclosed herein is a method of manufacturing a data storage media comprising mixing a photoactive material, a photosensitizer and an organic binder material to form a holographic composition, wherein the photoactive material undergoes a change in color upon reaction with the photosensitizer; and molding the holographic composition into holographic data storage media.

Disclosed herein too is a method for recording information comprising irradiating an article that comprises a photoactive material; a photosensitizer and an organic polymer, wherein the irradiation is conducted with electromagnetic energy having a wavelength of about 350 to about 1,100 nanometers, wherein the photoactive material can undergo a change in color upon reaction with the photosensitizer; and reacting the photoactive material to record data in holographic form.

Disclosed herein too is a method for using a holographic data storage media comprising irradiating an article that comprises a photoactive material; a photosensitizer, a fixing agent and an organic binder material; wherein the photoactive material undergoes a change in color upon reaction with the photosensitizer; and wherein the irradiation is conducted with electromagnetic energy having a first wavelength and wherein the irradiating that is conducted at the first wavelength facilitates the storage of data; reacting the photoactive material; and irradiating the article at a second wavelength to read the data.

Disclosed herein too is an article comprising a holographic composition comprising a photoactive material; a photosensitizer, a fixing agent and an organic binder material; wherein the photoactive material can change color upon reaction with the photosensitizer; wherein the article is used for data storage.

### DESCRIPTION OF THE FIGURES

Referring now to the figures, which are exemplary embodiments and wherein like elements are numbered alike:

FIG. 1 is a schematic representation of a holographic storage setup for (a) writing data and (b) reading stored data;

FIG. 2 is a schematic representation of a diffraction efficiency characterization setup for (a) writing plane wave holograms and (b) measuring diffracted light; and

FIG. 3 is a schematic representation of a holographic plane-wave characterization system.

### DETAILED DESCRIPTION

Disclosed herein are optical data storage media for use in holographic data storage and retrieval. Also disclosed herein are methods directed to holographic storage media preparation, data storage, and data retrieval. The holographic storage media is manufactured from a holographic composition that comprises a binder composition, a photoactive material, a photosensitizer and an optional fixing agent, wherein the photoactive material comprises a dye. In one embodiment, the photosensitizer is advantageously quenched (deactivated) by the fixer after data is written to the storage media, thereby preventing any further damage to the media when it is illuminated by electromagnetic radiation having a wavelength similar to the wavelength used to write the data. The deactivation can occur in response to a thermal, chemical and/or an electromagnetic radiation-based stimulus. The holographic storage media can therefore be written and read (i.e., data can be stored and retrieved respectively) using electromagnetic radiation having the same wavelength.

The binder composition can comprise an inorganic binder material, an organic binder material or a combination of an inorganic binder material with an organic binder material. Examples of suitable inorganic binder materials are silica (glass), alumina, or the like, or a combination comprising at least one of the foregoing inorganic binder materials.

Exemplary organic binder materials employed in the binder composition are optically transparent organic polymers. The organic polymer can be a thermoplastic polymer, a thermosetting polymer, or a combination of a thermoplastic polymer with a thermosetting polymer. The organic polymers can be oligomers, polymers, dendrimers, ionomers, copolymers such as for example, block copolymers, random copolymers, graft copolymers, star block copolymers; or the like, or a combination comprising at least one of the foregoing polymers. Examples of suitable thermoplastic organic polymers that can be used in the binder composition are polyacrylates, polymethacrylates, polyesters, polyolefins, polycarbonates, polystyrenes, polyesters, polyamideimides, polyarylates, polyarylsulfones, polyethersulfones, polyphenylene sulfides, polysulfones, polyimides, polyetherimides, polyetherketones, polyether etherketones, polyether ketone ketones, polysiloxanes, polyurethanes, polyethers, polyether amides, polyether esters, or the like, or a combination comprising at least one of the foregoing thermoplastic polymers.

Organic polymers that are not transparent to electromagnetic radiation can also be used in the binder composition if they can be modified to become transparent. For examples, polyolefins are not normally optically transparent because of the presence of large crystallites and/or spherulites. However, by copolymerizing polyolefins, they can be segregated into nanometer-sized domains that cause the copolymer to be optically transparent.

In one embodiment, the organic polymer can be chemically attached to the photochromic dye. The photochromic dye can be attached to the backbone of the polymer. In another embodiment, the photochromic dye can be attached to the polymer backbone as a substituent. The chemical attachment can include covalent bonding, ionic bonding, or the like.

Suitable organic polymers for use in the binder composition of the data storage devices are polycarbonates, cycloaliphatic polyesters, resorcinol arylate polyesters, as well as blends and copolymers of polycarbonates with polyesters. As used herein, the terms “polycarbonate”, “polycarbonate composition”, and “composition comprising aromatic carbonate chain units” includes compositions having structural units of the formula (I): 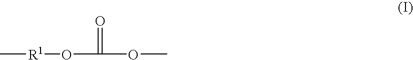
in which greater than or equal to about 60 percent of the total number of R¹ groups are aromatic organic radicals and the balance thereof are aliphatic, alicyclic, or aromatic radicals. Preferably, R¹ is an aromatic organic radical and, more preferably, a radical of the formula (II):
-A¹-Y¹-A²- (II)
wherein each of A¹ and A² is a monocyclic divalent aryl radical and Y¹ is a bridging radical having zero, one, or two atoms which separate A¹ from A². In an exemplary embodiment, one atom separates A¹ from A². Illustrative examples of radicals of this type are —O—, —S—, —S(O)—, —S(O)₂—, —C(O)—, methylene, cyclohexyl-methylene, 2-[2,2,1]-bicycloheptylidene, ethylidene, isopropylidene, neopentylidene, cyclohexylidene, cyclopentadecylidene, cyclododecylidene, adamantylidene, or the like. In another embodiment, zero atoms separate A¹ from A², with an illustrative example being biphenyl. The bridging radical Y¹ can be a saturated hydrocarbon group such as methylene, cyclohexylidene or isopropylidene.

Polycarbonates can be produced by interfacial or melt reactions of dihydroxy compounds in which only one atom separates A¹ and A². As used herein, the term “dihydroxy compound” includes, for example, bisphenol compounds having general formula (III) as follows: 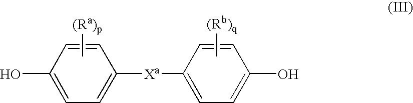
wherein R^{a} and R^{b} each independently represent hydrogen, a halogen atom, preferably bromine, or a monovalent hydrocarbon group; p and q are each independently integers from 0 to 4; and X^{a} represents one of the groups of formula (IV): 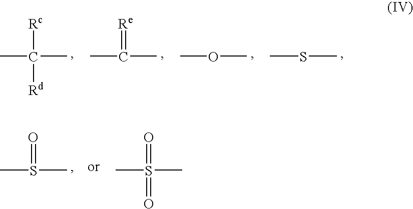
wherein R^{c} and R^{d} each independently represent a hydrogen atom or a monovalent linear or cyclic hydrocarbon group, and R^{e} is a divalent hydrocarbon group, oxygen, or sulfur.

Examples of the types of bisphenol compounds that may be represented by formula (III) include the bis(hydroxyaryl)alkane series such as, 1,1-bis(4-hydroxyphenyl)methane, 1,1-bis(4-hydroxyphenyl)ethane, 2,2-bis(4-hydroxyphenyl)propane (or bisphenol-A), 2,2-bis(4-hydroxyphenyl)butane, 2,2-bis(4-hydroxyphenyl)octane, 1,1-bis(4-hydroxyphenyl)propane, 1,1-bis(4-hydroxyphenyl)n-butane, bis(4-hydroxyphenyl)phenylmethane, 2,2-bis(4-hydroxy-1-methylphenyl)propane, 1,1-bis(4-hydroxy-t-butylphenyl)propane, 2,2-bis(4-hydroxy-3-bromophenyl)propane, or the like; bis(hydroxyaryl)cycloalkane series such as, 1,1-bis(4-hydroxyphenyl)cyclopentane, 1,1-bis(4-hydroxyphenyl)cyclohexane, or the like, or combinations comprising at least one of the foregoing bisphenol compounds.

Other bisphenol compounds that may be represented by formula (III) include those where X is —O—, —S—, —SO— or —S(O)₂—. Some examples of such bisphenol compounds are bis(hydroxyaryl)ethers such as 4,4′-dihydroxy diphenylether, 4,4′-dihydroxy-3,3′-dimethylphenyl ether, or the like; bis(hydroxy diaryl)sulfides, such as 4,4′-dihydroxy diphenyl sulfide, 4,4′-dihydroxy-3,3′-dimethyl diphenyl sulfide, or the like; bis(hydroxy diaryl) sulfoxides, such as, 4,4′-dihydroxy diphenyl sulfoxides, 4,4′-dihydroxy-3,3′-dimethyl diphenyl sulfoxides, or the like; bis(hydroxy diaryl)sulfones, such as 4,4′-dihydroxy diphenyl sulfone, 4,4′-dihydroxy-3,3′-dimethyl diphenyl sulfone, or the like; or combinations comprising at least one of the foregoing bisphenol compounds.

Other bisphenol compounds that may be utilized in the polycondensation of polycarbonate are represented by the formula (V) 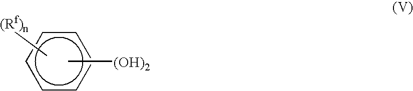
wherein, R^{f}, is a halogen atom of a hydrocarbon group having 1 to 10 carbon atoms or a halogen substituted hydrocarbon group; n is a value from 0 to 4. When n is at least 2, R^{f} may be the same or different. Examples of bisphenol compounds that may be represented by the formula (V), are resorcinol, substituted resorcinol compounds such as 5-methyl resorcin, 5-ethyl resorcin, 5-propyl resorcin, 5-butyl resorcin, 5-t-butyl resorcin, 5-phenyl resorcin, 5-cumyl resorcin, or the like; catechol, hydroquinone, substituted hydroquinones, such as 3-methyl hydroquinone, 3-ethyl hydroquinone, 3-propyl hydroquinone, 3-butyl hydroquinone, 3-t-butyl hydroquinone, 3-phenyl hydroquinone, 3-cumyl hydroquinone, or the like; or combinations comprising at least one of the foregoing bisphenol compounds.

Bisphenol compounds such as 2,2,2′,2′-tetrahydro-3,3,3′,3′-tetramethyl-1,1′-spirobiindane-6,6′-diol represented by the following formula (VI) may also be used.

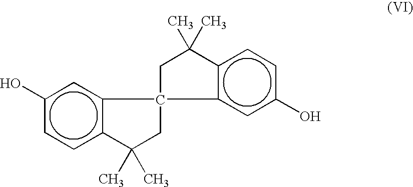

Suitable polycarbonates further include those derived from bisphenols containing alkyl cyclohexane units. Such polycarbonates have structural units corresponding to the formula (VII) 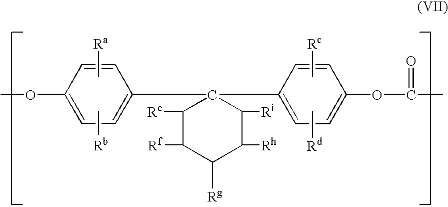
wherein R^{a}-R^{d} are each independently hydrogen, C₁-C₁₂ hydrocarbyl, or halogen; and R^{e}-Rⁱ are each independently hydrogen, C₁-C₁₂ hydrocarbyl. As used herein, “hydrocarbyl” refers to a residue that contains only carbon and hydrogen. The residue may be aliphatic or aromatic, straight-chain, cyclic, bicyclic, branched, saturated, or unsaturated. The hydrocarbyl residue may contain heteroatoms over and above the carbon and hydrogen members of the substituent residue. Thus, when specifically noted as containing such heteroatoms, the hydrocarbyl residue may also contain carbonyl groups, amino groups, hydroxyl groups, or the like, or it may contain heteroatoms within the backbone of the hydrocarbyl residue. Alkyl cyclohexane containing bisphenols, for example the reaction product of two moles of a phenol with one mole of a hydrogenated isophorone, are useful for making polycarbonate resins with high glass transition temperatures and high heat distortion temperatures. Such isophorone bisphenol-containing polycarbonates have structural units corresponding to the formula (VIII) 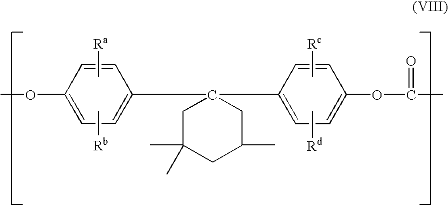
wherein R^{a}-R^{d} are as defined above. These isophorone bisphenol based resins, including polycarbonate copolymers made containing non-alkyl cyclohexane bisphenols and blends of alkyl cyclohexyl bisphenol containing polycarbonates with non-alkyl cyclohexyl bisphenol polycarbonates, are supplied by Bayer Co. under the APEC trade name. The preferred bisphenol compound is bisphenol A.

Typical carbonate precursors include the carbonyl halides, for example carbonyl chloride (phosgene), and carbonyl bromide; the bis-haloformates, for example the bis-haloformates of dihydric phenols such as bisphenol A, hydroquinone, or the like, and the bis-haloformates of glycols such as ethylene glycol and neopentyl glycol; and the diaryl carbonates, such as diphenyl carbonate, di(tolyl) carbonate, and di(naphthyl) carbonate. The preferred carbonate precursor for the interfacial reaction is carbonyl chloride.

It is also possible to employ polycarbonates resulting from the polymerization of two or more different dihydric phenols or a copolymer of a dihydric phenol with a glycol or with a hydroxy- or acid-terminated polyester or with a dibasic acid or with a hydroxy acid or with an aliphatic diacid in the event a carbonate copolymer rather than a homopolymer is desired for use. Generally, useful aliphatic diacids have about 2 to about 40 carbons. A preferred aliphatic diacid is dodecanedioic acid.

Branched polycarbonates, as well as blends of linear polycarbonate and a branched polycarbonate may also be used in the data storage device. The branched polycarbonates may be prepared by adding a branching agent during polymerization. These branching agents may comprise polyfunctional organic compounds containing at least three functional groups, which may be hydroxyl, carboxyl, carboxylic anhydride, haloformyl, or combinations comprising at least one of the foregoing branching agents. Examples of suitable branching agents include trimellitic acid, trimellitic anhydride, trimellitic trichloride, tris-p-hydroxy phenyl ethane, isatin-bis-phenol, tris-phenol TC (1,3,5-tris((p-hydroxyphenyl)isopropyl)benzene), tris-phenol PA (4(4(1,1-bis(p-hydroxyphenyl)-ethyl) α,α-dimethyl benzyl)phenol), 4-chloroformyl phthalic anhydride, trimesic acid, benzophenone tetracarboxylic acid, or the like, or combinations comprising at least one of the foregoing branching agents. The branching agents may be added at a level of about 0.05 to about 2.0 weight percent (wt %), based upon the total weight of the polycarbonate in the binder composition.

In one embodiment, the polycarbonate may be produced by a melt polycondensation reaction between a dihydroxy compound and a carbonic acid diester. Examples of suitable carbonic acid diesters that may be utilized to produce the polycarbonates are diphenyl carbonate, bis(2,4-dichlorophenyl)carbonate, bis(2,4,6-trichlorophenyl) carbonate, bis(2-cyanophenyl) carbonate, bis(o-nitrophenyl) carbonate, ditolyl carbonate, m-cresyl carbonate, dinaphthyl carbonate, bis(diphenyl) carbonate, diethyl carbonate, dimethyl carbonate, dibutyl carbonate, dicyclohexyl carbonate, or the like, or combinations comprising at least one of the foregoing carbonic acid diesters. The preferred carbonic acid diester is diphenyl carbonate.

A suitable number average molecular weight for the polycarbonate is about 3,000 to about 1,000,000 grams/mole (g/mole). In one embodiment, it is desirable for the number average molecular weight of the polycarbonate to be about 10,000 to about 100,000 g/mole. In another embodiment, it is desirable for the number average molecular weight of the polycarbonate to be about 20,000 to about 75,000 g/mole. In yet another embodiment, it is desirable for the number average molecular weight of the polycarbonate to be about 25,000 to about 35,000 g/mole.

Cycloaliphatic polyesters suitable for use in the binder composition are those that are characterized by optical transparency, improved weatherability and low water absorption. It is also generally desirable that the cycloaliphatic polyesters have good melt compatibility with the polycarbonate resins since the polyesters can be mixed with the polycarbonate resins for use in the binder composition. Cycloaliphatic polyesters are generally prepared by reaction of a diol with a dibasic acid or an acid derivative.

The diols used in the preparation of the cycloaliphatic polyester resins for use in the binder composition are straight chain, branched, or cycloaliphatic, preferably straight chain or branched alkane diols, and may contain from 2 to 12 carbon atoms. Suitable examples of diols include ethylene glycol, propylene glycol, e.g., 1,2- and 1,3-propylene glycol; butane diol, i.e., 1,3- and 1,4-butane diol; diethylene glycol, 2,2-dimethyl-1,3-propane diol, 2-ethyl, 2-methyl, 1,3-propane diol, 1,3- and 1,5-pentane diol, dipropylene glycol, 2-methyl-1,5-pentane diol, 1,6-hexane diol, 1,4-cyclohexane dimethanol and particularly its cis- and trans-isomers, triethylene glycol, 1,10-decane diol, ore the like, or a combination comprising at least one of the foregoing diols. If 1,4-cyclohexane dimethanol is to be used as the diol component, it is generally preferred to use a mixture of cis- to trans-isomers in ratios of about 1:4 to about 4:1. Within this range, it is generally desired to use a ratio of cis- to trans-isomers of about 1:3.

The diacids useful in the preparation of the cycloaliphatic polyester resins are aliphatic diacids that include carboxylic acids having two carboxyl groups each of which are attached to a saturated carbon in a saturated ring. Examples of suitable cycloaliphatic acids include decahydro naphthalene dicarboxylic acid, norbornene dicarboxylic acids, bicyclo octane dicarboxylic acids. Exemplary cycloaliphatic diacids are 1,4-cyclohexanedicarboxylic acid and trans-1,4-cyclohexanedicarboxylic acids. Linear aliphatic diacids are also useful provided the polyester has at least one monomer containing a cycloaliphatic ring. Illustrative examples of linear aliphatic diacids are succinic acid, adipic acid, dimethyl succinic acid, and azelaic acid. Mixtures of diacid and diols may also be used to make the cycloaliphatic polyesters.

Cyclohexanedicarboxylic acids and their chemical equivalents can be prepared, for example, by the hydrogenation of cycloaromatic diacids and corresponding derivatives such as isophthalic acid, terephthalic acid of naphthalenic acid in a suitable solvent, water or acetic acid at room temperature and at atmospheric pressure using suitable catalysts such as rhodium supported on a suitable carrier of carbon or alumina. They may also be prepared by the use of an inert liquid medium wherein an acid is at least partially soluble under reaction conditions and a catalyst of palladium or ruthenium in carbon or silica is used.

Typically, during hydrogenation, two or more isomers are obtained in which the carboxylic acid groups are in cis- or trans-positions. The cis- and trans-isomers can be separated by crystallization with or without a solvent or by distillation. Mixtures of the cis- and trans-isomers may also be used, and preferably when such a mixture is used, the trans-isomer can comprise at least about 75 wt % and the cis-isomer can comprise the remainder based on the total weight of cis- and trans-isomers combined. When a mixture of isomers or more than one diacid is used, a copolyester or a mixture of two polyesters may be used as the cycloaliphatic polyester resin.

Chemical equivalents of these diacids including esters may also be used in the preparation of the cycloaliphatic polyesters. Examples of suitable chemical equivalents for the diacids are alkyl esters, e.g., dialkyl esters, diaryl esters, anhydrides, acid chlorides, acid bromides, or the like, or combinations comprising at least one of the foregoing chemical equivalents. Exemplary chemical equivalents comprise the dialkyl esters of the cycloaliphatic diacids, with the most desirable being the dimethyl ester of the acid, particularly dimethyl-trans-1,4-cyclohexanedicarboxylate. Dimethyl-1,4-cyclohexanedicarboxylate can be obtained by ring hydrogenation of dimethylterephthalate.

The polyester resins can be obtained through the condensation or ester interchange polymerization of the diol or diol chemical equivalent component with the diacid or diacid chemical equivalent component and has recurring units of the formula (VII): 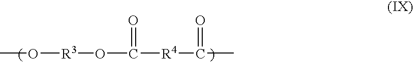
wherein R³ represents an alkyl or cycloalkyl radical containing 2 to 12 carbon atoms and which is the residue of a straight chain, branched, or cycloaliphatic alkane diol having 2 to 12 carbon atoms or chemical equivalents thereof; and R⁴ is an alkyl or a cycloaliphatic radical which is the decarboxylated residue derived from a diacid, with the proviso that at least one of R³ or R⁴ is a cycloalkyl group.

A preferred cycloaliphatic polyester is poly(1,4-cyclohexane-dimethanol-1,4-cyclohexanedicarboxylate) having recurring units of formula (VIII) 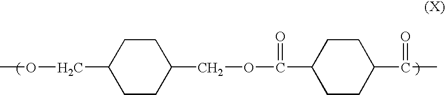
wherein in the formula (VII) R³ is a cyclohexane ring, and wherein R⁴ is a cyclohexane ring derived from cyclohexanedicarboxylate or a chemical equivalent thereof and is selected from the cis- or trans-isomer or a mixture of cis- and trans-isomers thereof. Cycloaliphatic polyester resins can be generally made in the presence of a suitable catalyst such as a tetra(2-ethyl hexyl)titanate, in a suitable amount, typically about 50 to 400 ppm of titanium based upon the total weight of the final product.

Also contemplated herein are copolyesters comprising about 0.5 to about 30 percent by weight (wt %), of units derived from aliphatic acids and/or aliphatic polyols with the remainder of the polyester being a resorcinol aryl polyesters derived from aromatic diols and aromatic polyols.

Polyarylates that can be used in the binder composition refers to polyesters of aromatic dicarboxylic acids and bisphenols. Polyarylate copolymers including carbonate linkages in addition to the aryl ester linkages, known as polyester-carbonates, are also suitable. These aryl esters may be used alone or in combination with each other or more preferably in combination with bisphenol polycarbonates. These organic polymers can be prepared in solution or by melt polymerization from aromatic dicarboxylic acids or their ester forming derivatives and bisphenols and their derivatives.

Examples of aromatic dicarboxylic acids represented by the decarboxylated residue R² are isophthalic or terephthalic acid, 1,2-di(p-carboxyphenyl)ethane, 4,4′-dicarboxydiphenyl ether, 4,4′ bisbenzoic acid, and mixtures thereof. All of these acids contain at least one aromatic nucleus. Acids containing fused rings can also be present, such as in 1,4- 1,5- or 2,6-naphthalene dicarboxylic acids. The preferred dicarboxylic acids are terephthalic acid, isophthalic acid, naphthalene dicarboxylic acid, or the like, or a combination comprising at least one of the foregoing dicarboxylic acids.

Blends of organic polymers may also be used as the binder composition for the data storage devices. Preferred organic polymer blends are polycarbonate (PC)-poly(1,4-cyclohexane-dimethanol-1,4-cyclohexanedicarboxylate) (PCCD), PC-poly(cyclohexanedimethanol-co-ethylene terephthalate) (PETG), PC-polyethylene terephthalate (PET), PC-polybutylene terephthalate (PBT), PC-polymethylmethacrylate (PMMA), PC-PCCD-PETG, resorcinol aryl polyester-PCCD, resorcinol aryl polyester-PETG, PC-resorcinol aryl polyester, resorcinol aryl polyester-polymethylmethacrylate (PMMA), resorcinol aryl polyester-PCCD-PETG, or the like, or a combination comprising at least one of the foregoing.

Binary blends, ternary blends and blends having more than three resins may also be used in the polymeric alloys. When a binary blend or ternary blend is used in the polymeric alloy, one of the polymeric resins in the alloy may comprise about 1 to about 99 weight percent (wt %) based on the total weight of the composition. Within this range, it is generally desirable to have the one of the polymeric resins in an amount greater than or equal to about 20, preferably greater than or equal to about 30 and more preferably greater than or equal to about 40 wt %, based on the total weight of the composition. Also desirable within this range, is an amount of less than or equal to about 90, preferably less than or equal to about 80 and more preferably less than or equal to about 60 wt % based on the total weight of the composition. When ternary blends of blends having more than three polymeric resins are used, the various polymeric resins may be present in any desirable weight ratio.

Examples of suitable thermosetting polymers that may be used in the binder composition are polysiloxanes, phenolics, polyurethanes, epoxies, polyesters, polyamides, polyacrylates, polymethacrylates, or the like, or a combination comprising at least one of the foregoing thermosetting polymers. In one embodiment, the organic binder material can be a low molecular weight precursor to a thermosetting polymer. Low molecular weights as defined herein are molecules having a molecular weight of less than or equal to about 1000 g/mole.

As noted above, the photoactive material is a dye. The dye can be activated by only the photosensitizer, when the holographic composition is irradiated. The dye is bistable, i.e., it can exist in either a reacted state or in an unreacted state. When the dye is irradiated in the presence of a photosensitizer, the dye changes color. The dye can change from a first color to a second color. Alternative the dye can change from a colorless state (bleached state) to a colored state. In another embodiment, the dye can change from a colored state to a bleached state. This change in color correlates to a change in the refractive index of the material, which is used to store data in the media. The change in the refractive index is used to produce a hologram that can be used to store data. The data is stored in three dimensions. It is desirable for the dye in its reacted or unreacted state to be stable for extended periods of time, in order to preserve the stored data. It is desirable for the dye to undergo a reaction only in the presence of a photosensitizer. When the photosensitizer is absent or is quenched, it is desirable for the dye to either continue to exist in either its unreacted state or its reacted state. It is also desirable for the dye to withstand the processing temperature for the holographic composition without undergoing any chemical changes.

The portions of the dye that are illuminated by electromagnetic radiation change color in the presence of the photosensitizer. The change in color facilitates the storage of data by causing a change in refractive index. The dye that does not change color forms the background. Generally, after the change in color (i.e., writing of data), the photosensitizer is deactivated. A fixing agent can optionally be used to deactivate the photosensitizer. This fixing agent can also be used to prevent the background from undergoing a subsequent change in color upon exposing to color inducing radiation.

As noted above, a suitable dye is one that is bistable and that can react in the presence of a photosensitizer upon being irradiated by electromagnetic radiation. Dyes can be metal complexes or organic compounds. Metal complexes include group IB metal complexes, group IIB metal complexes, group VIII metal complexes, or the like, or a combination comprising at least one of the foregoing complexes.

Examples of suitable organic dyes that can be used as photoactive materials are anthranones and their derivatives; anthraquinones and their derivatives; croconines and their derivatives; monoazos, disazos, trisazos and their derivatives; benzimidazolones and their derivatives; diketo pyrrole pyrroles and their derivatives; dioxazines and their derivatives; diarylides and their derivatives; indanthrones and their derivatives; isoindolines and their derivatives; isoindolinones and their derivatives; naphtols and their derivatives; perinones and their derivatives; perylenes and their derivatives such as perylenic acid anhydride or perylenic acid imide; ansanthrones and their derivative; dibenzpyrenequinones and their derivatives; pyranthrones and their derivatives; bioranthorones and their derivatives; isobioranthorone and their derivatives; diphenylmethane, and triphenylmethane, type pigments; cyanine and azomethine type pigments; indigoid type pigments; bisbenzoimidazole type pigments; azulenium salts; pyrylium salts; thiapyrylium salts; benzopyrylium salts; phthalocyanines and their derivatives, pryanthrones and their derivatives; quinacidones and their derivatives; quinophthalones and their derivatives; squaraines and their derivatives; squarilylums and their derivatives; leuco dyes and their derivatives, deuterated leuco dyes and their derivatives; leuco-azine dyes; acridines; di-and tri-arylmethane, dyes; quinoneamines; o-nitro-substituted arylidene dyes, aryl nitrone dyes, or the like, or a combination comprising at least one of the foregoing.

Exemplary dyes that can be used as photoactive materials are leuco dyes. Leuco dyes generally have the structure (XI) shown below: 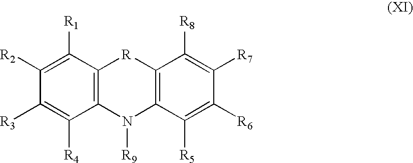
where R is sulfur or oxygen and R₁, R₂, R₃, R₄, R₅, R₆, R₇, and R₈ are the same or different and can independently be hydrogen, hydroxyl, alkyl, amine, —N(CH₃)₂; —N(C₂H₅)₂; or the like, or a combination comprising at least one of the foregoing substituents. R₉ in the equation (XI) can be hydrogen.

Examples of suitable leuco dyes are shown below in the following structures 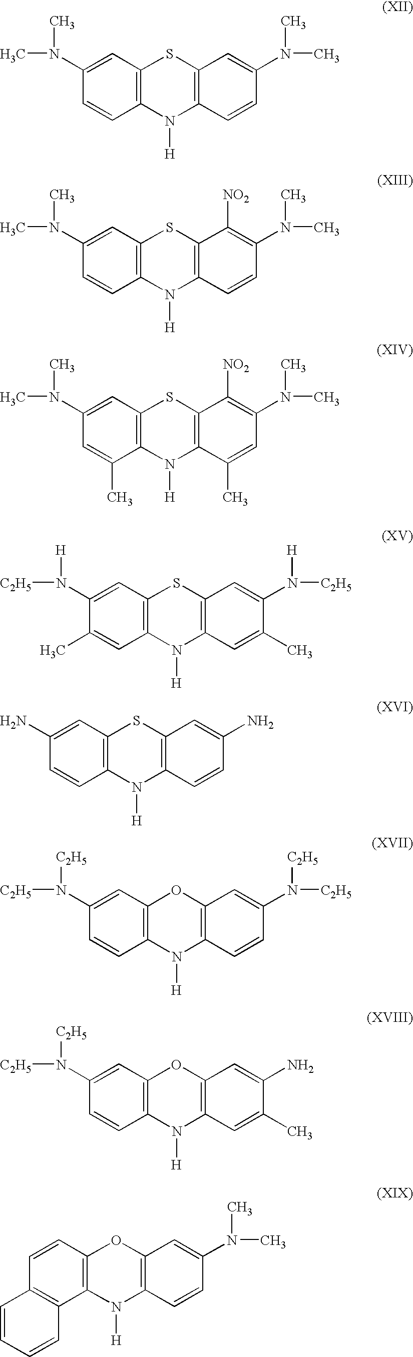 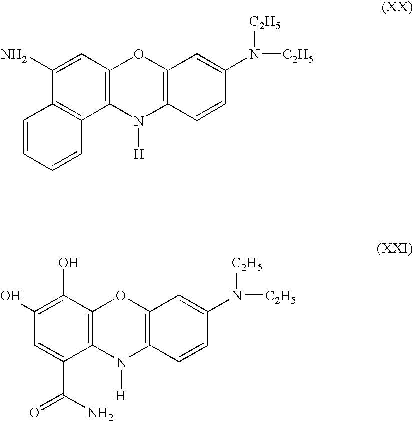
or the like, or a combination comprising at least one of the foregoing leuco dyes. The aforementioned leuco dyes are in their colorless form. Upon reaction with the photosensitizer, the aforementioned colorless leuco dyes can change to their colored form, which can be seen in the structure (XXII) below: 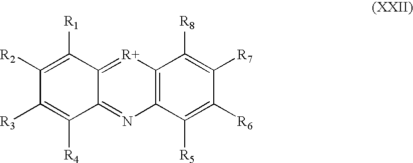
where R, R₁, R₂, R₃, R₄, R₅, R₆, R₇ and R₈ are the same as indicated for the structure (XV).

Leuco dyes useful as reactive species include acrylated leuco azine, phenoxazine, and phenothiazine, which can, in part, be represented by the structural formula (XXIII) 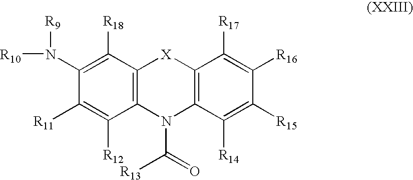
wherein X is selected from O, S, and —N—R₁₉, with S being preferred; R₉ and R₁₀ are independently selected from H and alkyl groups of 1 to about 4 carbon atoms; R₁₁, R₁₂, R₁₄, and R₁₅ are independently selected from H and alkyl groups of 1 to about 4 carbon atoms, preferably methyl; R₁₃ is selected from alkyl groups of 1 to about 16 carbon atoms, alkoxy groups of 1 to about 16 carbon atoms, and aryl groups of up to about 16 carbon atoms; R₁₆ is selected from —N(R₉)(R₁₀), H, alkyl groups of 1 to about 4 carbon atoms, wherein R₉ and R₁₀ are independently selected and defined as above; R₁₇ and R₁₈ are independently selected from H and alkyl groups of 1 to about 4 carbon atoms; and R₁₉ is selected from alkyl groups of 1 to about 4 carbon atoms and aryl groups of up to about 11 carbon atoms (preferably, phenyl groups). The following compounds are examples of this type of leuco dye:

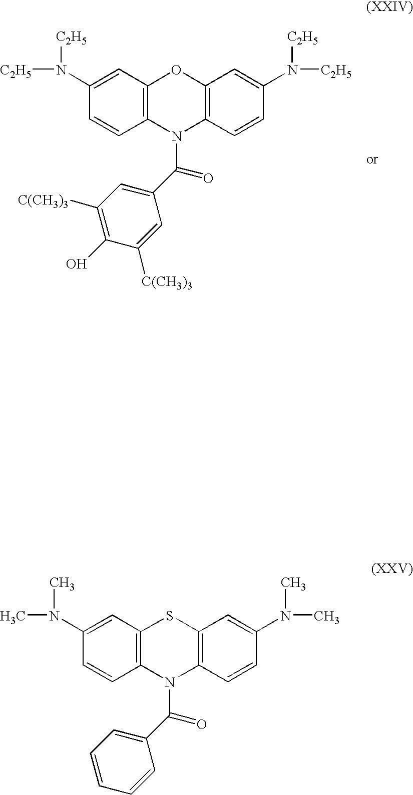

Other useful leuco dyes include, but are not limited to, Leuco Crystal Violet (4,4′,4″-methylidynetris-(N,N-dimethylaniline)), Leuco Malachite Green (p,p′-benzylidenebis-(N,N-dimethylaniline)), Leuco Atacryl Orange-LGM (Color Index Basic Orange 21, Comp. No. 48035 (a Fischer's base type compound)) having the structure (XXVI)

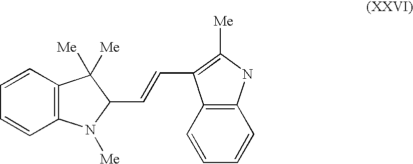

Leuco Atacryl Brilliant Red-4G (Color Index Basic Red 14) having the structure (XXVII)

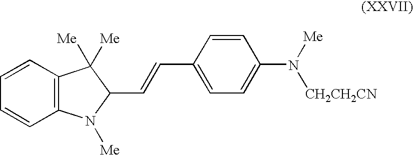

Leuco Atacryl Yellow-R (Color Index Basic Yellow 11, Comp. No. 48055) having the structure (XXVII) 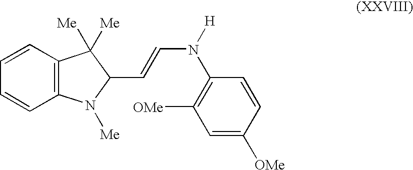
Leuco Ethyl Violet (4,4′,4″-methylidynetris-(N,N-diethylaniline), Leuco Victoria Blu-BGO (Color Index Basic Blue 728a, Comp. No. 44040; 4,4′-methylidynebis-(N,N,-dimethylaniline)-4-(N-ethyl-1-napthalamine)), and LeucoAtlantic Fuchsine Crude (4,4′,4″-methylidynetris-aniline).

Other examples of suitable leuco dyes are: aminotriarylmethanes, aminoxanthenes, aminothioxanthenes, amino-9,10-dihydroacridines, aminophenoxazines, aminophenothiazines, aminodihydrophenazines, aminodiphenylmethanes, leuco indamines, aminohydrocinnamic acids (e.g., cyanoethanes, leuco methines), hydrazines, leuco indigoid dyes, amino-2,3dihydroanthraquinones, tetrahalo-p,p′-biphenols-2(p-hydroxyphenyl)-4,5-diphenylimidazoles, phenethylanilines, or the like, or a combination comprising at least one of the foregoing leuco dyes.

Exemplary aminoarylmethanes are bis(4-amino-2-butylphenyl)(p-dimethylaminophenyl)methane, bis(4-amino-2-chlorophenyl)(p-aminophenyl)methane, bis(4-amino-3-chlorophenyl)(o-chlorophenyl)methane, bis(4-amino-3-chlorophenyl)phenylmethane, bis(4-amino-3,5-diethylpheiayl)(o-chlorophenyl)methane, bis(4-amino-3,5-diethylphenyl)(o-ethoxyphenyl)methane, bis(4-amino-3,5-diethylphenyl)(p-methoxyphenyl)methane, bis(4-amino-3,5-diethylphenyl)phenylmethane, bis(4-amino-3-ethylphenyl)(o-chlorophenyl)methane, bis(p-aminophenyl)(4-amino-m-tolyl)methane, bis(p-aminophenyl)(o-chlorophenyl)methane, bis(p-aminophenyl)(p-chlorophenyl)methane, bis(p-aminophenyl)(2,4-dichlorophenyl)methane, bis(p-aminophenyl)(2,5-dichlorophenyl)methane, bis(p-aminophenyl)(2,6-dichlorophenyl)methane, bis(p-aminophenyl)phenylmethane, bis(4-amino-o-tolyl)(p-chlorophenyl)methane, bis(4-amino-o-tolyl)(2,4-dichlorophenyl)methane, bis(p-anilinophenyl)(4-amino-m-tolyl)methane, bis(4-benzylamino-2-cyanophenyl)(p-anilinophenyl)methane, bis(p-benzylethylaminophenyl)(p-chlorophenyl)methane, bis(p-benzylethylaminophenyl)(p-diethylaminophenyl)methane, bis(p-benzylethylaminophenyl)(p-dimethylaminophenyl)methane, bis(4-benzylethylamino-o-tolyl)(methoxyphenyl)methane, bis(p-benzylethylaminophenyl)-phenylmethane, bis(4-benzylethylamino-o-tolyl)(o-chlorophenyl)methane, bis(4-benzylethylamino-o-tolyl)(p-diethylaminophenyl)methane, bis(4-benzylethylamino-o-tolyl)(4-diethylamino-o-tolyl)methane, bis(4-benzylethylamino-o-tolyl)(p-dimethylaminophenyl)methane, bis[2-chloro-4-(2-diethylaminoethyl)ethylaminophenyl](o-chlorophenyl)methane, bis[p-bis(2-cyanoethyl)aminophenyl]phenylmethane, bis[p-(2-cyanoethyl)ethylamino-o-tolyl(p-dimethylaminophenyl)]methane, bis[p-(2-cyanoethyl)methylaminophenyl](p-diethylaminophenyl)methane, bis(p-dibutylaminophenyl)[p-(2-cyanoethyl)methylaminophenyl]methane, bis(4-diethylamino-o-tolyl)(p-diphenylaminophenyl)methane, bis(4-diethylamino-2-butoxyphenyl)(p-diethylaminophenyl)methane, bis(4-diethylamino-2-fluorophenyl)o-tolylmethane, bis(p-diethylaminophenyl)(p-aminophenyl)methane, bis(p-diethylaminophenyl)(4-anilino-1-naphthyl)methane, bis(p-diethylaminophenyl)(m-butoxyphenyl)methane, bis(p-diethylaminophenyl)(o-chlorophenyl)methane, bis(p-diethylaminophenyl)(p-cyanophenyl)methane, bis(p-diethylaminophenyl)(2,4-dichlorophenyl)methane, bis(p-diethylaminophenyl)(4-diethylamino-1-naphthyl)methane, bis(p-diethylaminophenyl)(4-ethylamino-1-naphthyl)methane, bis(p-diethylaminophenyl)2-naphthylmethane, bis(p-diethylaminophenyl)(p-nitrophenyl)methane, bis(p-diethylaminophenyl)2-pyridylmethane, bis(p-diethylamino-m-tolyl)(p-diethylaminophenyl)methane, bis(4-diethylamino-o-tolyl)(o-chlorophenyl)methane, bis(4-diethylamino-o-tolyl)(p-diethylaminophenyl)methane, bis(4-amino-3,5-diethylphenyl)(o-ethoxyphenyl)methane, bis(4-diethylamino-o-tolyl)phenylmethane, bis(4-dimethylamino-2-bromophenyl)phenylmethane, bis(p-dimethylaminophenyl)(4-anilino-1-naphthyl)methane, bis(p-dimethylaminophenyl)(p-butylaminophenyl)methane, bis(p-dimethylaminophenyl)(p-sec-butylethylaminophenyl)methane, bis(p-dimethylaminophenyl)(p-chlorophenyl)methane, bis(p-dimethylaminophenyl)(p-diethylaminophenyl)methane, bis(p-dimethylanilinophenyl)(4-dimethylamino-1-naphthyl)methane, bis(p-dimethylaminophenyl)( 6-dimethylamino-m-tolyl)methane, bis(p-dimethylaminophenyl)(4-dimethylamino-o-tolyl)methane, bis(p-dimethylaminophenyl)(4-ethylamino-1-naphthyl)methane, bis(p-dimethylaminophenyl)(p-hexyloxyphenyl)methane, bis(p-dimethylaminophenyl)(p-methoxyphenyl)methane, bis(p-dimethylaminophenyl)(5-methyl-2-pyridyl)methane, 9bis(p-dimethylaminophenyl)2-quinolylmethane, bis(p-dimethylaminophenyl)-o-tolylmethane, bis(p-dimethylaminophenyl)(1,3,3-trimethyl-2-indolinylidenemethyl)methane, bis(4-dimethylamino-o-tolyl)(p-aminophenyl)methane, bis(4-dimethylamino-o-tolyl)(o-bromophenyl)methane, bis(4-dimethylamino-o-tolyl)(o-cyanophenyl)methane, bis(4-dimethylamino-o-tolyl)(o-fluorophenyl)methane, bis(4-dimethylamino-o-tolyl)1-naphthylmethane, bis(4-dimethylamino-o-tolyl)phenylmethane, bis(p-ethylaminophenyl)(o-chlorophenyl)methane, bis(4-ethylamino-m-tolyl)(o-methoxyphenyl)methane, bis(4-ethylamino-m-tolyl)(p-methoxyphenyl)methane, bis(4-ethylamino-m-tolyl)(p-dimethylaminophenyl)methane, bis(4-ethylamino-m-tolyl)(p-hydroxyphenyl)methane, bis[4-ethyl(2-hydroxyethyl)amino-m-tolyl](p-diethylaminophenyl)methane, bis[p-(2-hydroxyethyl)aminophenyl](o-chlorophenyl)methane, bis[p-(bis(2-hydroxyethyl)aminophenyl](4-diethylamino-o-tolyl)methane, bis[p-(2-methoxyethyl)aminophenyl]phenylmethane, bis(p-methylaminophenyl)(o-hydroxyphenyl)methane, bis(p-propylaminophenyl)(m-bromophenyl)methane, tris(4-amino-o-tolyl)methane, tris(4-anilino-o-tolyl)methane, tris(p-benzylaminophenyl)methane, tris[4-bis(2-cyanoethyl)amino-o-tolyl]methane, tris[p-(2-cyanoethyl)ethylaminophenyl]methane, tris(p-dibutylaminophenyl)methane, tris(p-d1-n-butylaminophenyl)methane, tris(4-diethylamino-2-chlorophenyl)methane, tris(p-diethylaminophenyl)methane, tris(4-diethylamino-o-tolyl)methane, tris(p-dihexylamino-o-tolyl)methane, tris(4-dimethylamino-o-tolyl)methane, tris(p-hexylaminophenyl)methane, tris[p-bis(2-hydroxyethyl)aminophenyl]methane, tris(p-methylaminophenyl)methane, tris(p-dioctadecylanilinophenyl)methane, tris(4-diethylamino-2-fluorophenyl)methane, tris(4-dimethylamino-2-fluorophenyl)methane, bis(2-bromo-4-diethylaminophenyl)phenylmethane, bis(2-butoxy-4-diethylaminophenyl)phenylmethane, bis(4-diethylamino-o-tolyl)(p-methoxyphenyl)methane, bis(4-diethylamino-2-methoxyphenyl)(p-nitrophenyl)methane, bis(4-diethylamino-1-naphthyl)(4-diethylaamino-o-tolyl)methane, bis(4-diethylamino-o-tolyl)1-naphthylmethane, 4-[bis(4-diethylamino-o-tolyl)-methyl]-acetanilide, tris(4-dimethylamino-2-chlorophenyl)methane, bis(4-dimethylamino-2,5-dimethylphenyl)phenylmethane, bis(4-dimethylamino-o-tolyl)(o-bromophenyl)methane, bis(4-ethylbenzylamino-o-tolyl)(p-methoxyphenyl)methane, tris(p-dioctylamino-o-tolyl)methane, bis(4-diethylamino-o-tolyl)-4-methoxy-1-naphthyl methane, bis(4-diethylamino-o-tolyl)-3,4,5-trimethoxyphenyl methane, bis(4-diethylamino-o-tolyl)-p-hydroxyphenyl methane, 5-[bis(4-diethylamino-o-tolyl)-methyl]-2,3-cresotic acid, 4-[bis(4-diethylamino-o-tolyl)ethyl]-phenol, 4-[bis(4-diethylamino-o-tolyl)-methyl]-acetanilide, 4-[bis(4-diethylamino-o-tolyl)-methyl]-phenylacetate, 4-[bis(4-diethylamino-o-tolyl)-methylbenzoic acid, 4-[bis(4-diethylamino-o-tolyl)-methyl]-diphenyl sulfone, 4-[bis(4-diethylamino-o-tolyl)-methyl]-phenylmethyl sulfone, 4-[bis(4-diethylamino-o-tolyl)-methyl]-methylsulfonanilide, bis(4-diethylamino-o-tolyl)(2-diethylamino-4-methyl-5-thiazolyl)methane, bis(4-diethylamino-o-tolyl)(2-diethylamino-5-methyl-6-benzoxazolyl)methane, bis(4-diethylamino-o-tolyl)(2-diethylamino-5-methyl-6-benzothiazolyl)methane, bis(4-diethylamino-o-tolyl)(1-ethyl-2-methyl-3-indolyl)methane, bis(4-diethylamino-o-tolyl)(1-benzyl-2-methyl-3-indolyl)methane, bis(4-diethylamino-o-tolyl)(1-ethyl-2-methyl-5methoxy-3-indolyl)methane, bis(1-o-xylyl-2-methyl-3-indolyl)(4-diethylamino-o tolyl)methane, bis(4-diethylamino-o-tolyl)(1-ethyl-5-indolinyl)methane, bis(1-isobutyl-6-methyl-5-indolinyl)(4-diethylaminoo-tolyl)methane, bis(4-diethylamino-o-tolyl)(8-methyl-9-julolindinyl)methane, bis(4-diethylamino-2-acetamidophenyl)(4-diethylaminoo-tolyl)methane, 4-[bis(4-diethylamino-o-tolyl)methyl]-N-ethylacetanilide, bis[4-(1-phenyl-2,3-dimethyl-5-pyrazolinyl)](4-diethylamino-o-tolyl)methane, bis(4-diethylamino-o-tolyl)(7-diethylamino-4-methyl-3-coumarinyl)methane, bis(4-diethylamino-o-tolyl)(4-acrylamidophenyl)methane, bis(4-dethylamino-o-tolyl)(p-benzylthiophenyl)methane, bis(4-diethylamino-o-tolyl)(4-isopropylthio-3-methylphenyl)methane, bis(4-diethylamino-o-tolyl)-(4-chlorobenzylthiophenyl)methane, bis(4-diethylamino-o-tolyl)(2-furyl)methane, bis(4-diethylamino-o-tolyl)(3,4-methylenedioxyphenyl)methane, bis(4-diethylamino-o-tolyl)(3,4-dimethoxyphenyl)methane, bis(4-diethylamino-o-tolyl)(3-methyl-2-thienyl)methane, bis(4-diethylamino-o-tolyl)(2,4-dimethoxyphenyl)methane, bis[4-(2-cyanoethyl)(2-hydroxyethyl)amino-o-tolyl](p-benzylthiophenyl)methane, bis[4-(2-cyanoethyl)(2-hydroxyethyl)amino-o-tolyl]2-thienylmethane, bis(4-dibutylamino-o-tolyl)2-thienylmethane, bis(4-diethylamino-2-ethylphenyl)(3,4-methylenedioxyphenyl)methane, bis(4-diethylamino-2-fluorophenyl)(p-benzylthiophenyl)methane, bis(4-diethylamino-2-fluorophenyl)(3,4-methylenedioxyphenyl)methane, bis(4-diethylamino-o-tolyl)(p-methylthiophenyl)methane, bis(4-diethylamino-o-tolyl)2-thienylmethane, bis(4-dimethylamino-2-hexylphenyl)(p-butylthiophenyl)methane, bis[4-(N-ethylanilino)-o-tolyl](3,4-dibutoxyphenyl)methane, bis[4-bis(2-hydroxyethyl)amino-2-fluorophenyl](p-benzylthiophenyl)methane, bis(4-diethylamino-o-tolyl)-p-chlorophenyl methane, bis(4-diethylamino-o-tolyl)-p-bromophenyl methane, bis(4-diethylamino-o-tolyl)-p-fluorophenyl methane, bis(4-diethylanilino-o-tolyl)-p-tolyl methane, bis(4-diethylanilino-o-tolyl)-4-methoxy-1-naphthyl methane, bis(4-diethylamino-o-tolyl)3,4,5-trimethoxyphenyl methane, bis(4-diethylamino-o-tolyl)-p-hydroxyphenyl methane, bis(4-diethylamino-o-tolyl)-3-methylthienyl methane, or the like, or a combination comprising at least one of the foregoing aminoarylmethanes.

Examples of deuterated leuco dyes that may be used as the photoactive materials in the holographic storage composition include deuterated aminotriarylmethanes, deuterated aminoxanthenes, deuterated aminothioxanthenes, deuterated amino-9,10-dihydroacridines, deuterated aminophenoxazines, deuterated aminophenothiazines, deuterated aminodihydrophenazines, deuterated aminodiphenylmethanes, deuterated leuco indamines, deuterated aminohydrocinnamic acids (cyanoethanes, leuco methines), deuterated hydrazines, deuterated leuco indigoid dyes, deuterated amino-2,3-dihydroanthraquinones, deuterated tetrahalo-p,p′-biphenols, deuterated 2(p-hydroxyphenyl)-4,5-diphenylimidazoles, deuterated phenethylanilines, or a combination comprising at least one of the foregoing deuterated leuco dyes.

In one embodiment, the photoactive material can be covalently bonded to the organic material binder. In another embodiment, it is desirable for the leuco dye or a leuco dye derivative to be covalently bonded to the organic material binder. When the organic material binder is polymeric, the leuco dye or the leuco dye derivative can be covalently bonded to the chain backbone or can be a substituent off the chain backbone.

It is desirable for the photoactive material to be present in the holographic storage composition in an amount of 0.1 to about 50 weight percent, based on the total weight of the holographic composition. In one embodiment, the photoactive material to be present in the holographic storage composition in an amount of 1 to about 40 weight percent, based on the total weight of the holographic composition. In another embodiment, the photoactive material is present in the holographic storage composition in an amount of 2 to about 20 weight percent, based on the total weight of the holographic composition. In yet another embodiment, the photoactive material is present in the holographic storage composition in an amount of 3 to about 10 weight percent, based on the total weight of the holographic composition.

The holographic composition also comprises a photosensitizer. The photosensitizer facilitates a change the color of the photoactive material, when the photoactive material is irradiated. In one embodiment, the photosensitizer is a species that reacts with the photoactive material, in a catalytic or stoichiometric manner, thereby promoting a change in color in the photoactive material. It is desirable for the photosensitizer to be deactivated after the writing of the data by electromagnetic radiation is completed. In one embodiment, the photosensitizer can be deactivated by using a fixing agent that chemically reacts with the photosensitizer to deactivate the photosensitizer. In another embodiment, the photosensitizer can be deactivated by changing the temperature. In yet another embodiment, the photosensitizer can be deactivated by using electromagnetic radiation.

The term “deactivation” as used herein refers to the prevention of additional color formation in the photoactive material after the data writing process has occurred. Deactivation occurs when the composition is subjected to stimulus effective to render the exposed area of the composition relatively insensitive to color-inducing electromagnetic radiation. As noted above, the deactivation can occur in response to a thermal, chemical and/or an electromagnetic radiation-based stimulus. In general when deactivation has occurred, the holographic composition is rendered practically insensitive to color formation upon exposure to actinic radiation. However, the degree of deactivation can be varied depending upon the amount of the thermal, chemical or electromagnetic radiation-based stimulus.

Examples of suitable photosensitizers are photoactivatable oxidants, one photon photosensitizers, two photon photosensitizers, three photon photosensitizers, multiphoton photosensitizers, acids, bases, salts, free radical photosensitizers, cationic photosensitizers, or the like, or a combination comprising at least one of the foregoing photosensitizers. In one embodiment, the photosensitizer can be a dye. For example, one dye (e.g., a coumarin) can serve as a photosensitizer for another dye (e.g., a leuco dye), which is the photoactive material. In another embodiment, the photosensitizer can be an electron donor or an electron acceptor that facilitates activation of the photoactive material.

Examples of suitable photo-oxidants include a hexaarylbiimidazole compound (HABI), a halogenated compound having a bond dissociation energy effective to produce a first halogen as a free radical of not less than about 40 kilocalories per mole, and having not more than one hydrogen attached thereto, a sulfonyl halide, R—SO₂—X wherein R is a member of the group consisting of alkyl, alkenyl, cycloalkyl, aryl, alkaryl, or aralkyl and X is chlorine or bromine, a sulfenyl halide of the formula R′—S—X′ wherein R′ and X′ have the same meaning as R and X in R—SO₂—X above, a tetraaryl hydrazine, a benzothiazolyl disulfide, a polymethacrylaldehyde, an alkylidene 2,5-cyclohexadien-1-one, an azobenzyl, a nitroso, alkyl (T1), a peroxides, a haloamine, or a combination comprising at least one of the foregoing photoactivatable oxidants.

A suitable photoactivatable oxidant for leuco dyes, deuterated leuco dyes or triarylmethanes is a hexaarylbiimadazole. Suitable examples of hexaarylbiimidazoles that may be used include, 2,2′-bis(o-bromophenyl)-4,4′,5,5′-tetraphenylbiimidazole, 2,2′-bis(p-bromophenyl)-4,4′,5,5′-tetraphenylbiimidazole, 2,2′-bis(p-carboxyphenyl)-4,4′,5,5′-tetraphenylbiimidazole, 2,2′-bis(o-chlorophenyl)-4,4′,5,5′-tetrakis(p-methoxyphenyl)-biimidazole, 2,2′-bis(o-chlorophenyl)-4,4′,5,5′-tetraphenylbiimidazole, 2,2′-bis(o-chlorophenyl)-4,4′,5,5′-tetrakis(p-methoxyphenyl)biimidazole, 2,2′-bis(13-cyanophenyl)-4,41,5,5′-tetrakis (p-methoxyphenyl)-biimidazole, 2,2′-bis(2,4-dichlorophenyl)-4,4′,5,5′-tetraphenylbiimidazole, 2,2′-bis(2,4-dimethoxyphenyl)-4,4′,5,5′-tetraphenylbiimidazole, 2,2-bis(o-ethoxyphenyl)-4,4′,5,5′-tetraphenylbiimidazole, 2,2′-bis(m-fluorophenyl)-4,4,5,5′-tetraphenylbiimidazole, 2,2′-bis(o-fluorophenyl)-4,4′,5,5′-tetraphenylbiimidazole, 2,2′-bis(p-fluorophenyl)-4,4′,5,5′-tetraphenylbiimidazole, 2,2′-bis(o-hexoxyphenyl)-4,4,5,5′-tetraphenylbiimidazole, 2,2′-bis(o-hexylphenyl)-4,4′,5,5′-tetrakis (p-methoxyphenyl)-biimidazole, 2,2′-bis(3,4-methylenedioxyphenyl)-4,4′,5,5′-tetraphenylbiimidazole, 2,2′-bis(o-chlorophenyl)-4,4′,5,5′-tetrakis (m-methoxyphenyl)biimidazole, 2,2′-bis(o-chlorophenyl)-4,4′,5,5′-tetrakis [m-(beta phenoxyethoxyphenyl)]biimidazole, 2,2′-bis(2,6-dichlorophenyl)-4,4′,5,5′-tetraphenylbiimidazole, 2,2′-bis(o-methoxyphenyl)-4,4′,5,5′-tetraphenylbiimidazole, 2,2′-bis(p-methoxyphenyl)-4,4′-bis(o-methoxyphenyl) 5,5′-diphenylbiimidazole, 2,2′-bis(o-nitrophenyl)-4,4′,5,5′-tetraphenylbiimidazole, 2,2-bis(p-phenylsulfonylphenyl)-4,4,5,5′-tetraphenylbiimidazole, 2,2′-bis(p-sulfamoylphenyl)-4,4′,5,5′-tetraphenylbiimidazole, 2,2′-bis(2,4,6-trimethylphenyl)-4,4′,5,5′-tetraphenylbiimidazole, 2,2′-d1-4-biphenylyl-4,4′,5,5′-tetraphenylbiimidazole, 2,2′-d1-1-naphthyl-4,4′,5,5′-tetrakis(p-methoxyphenyl)biimidazole, 2,2′-d1-9-phenanthryl-4,4′,5,5′-tetrakis(p-methoxyphenyl)biimidazole, 2,2′-diphenyl-4,4′,5,5-tetra-4-biphenylbiimidazole, 2,2′-diphenyl-4,4′5,5′-tetra-2,4-xylylbiimidazole, 2,2′-d1-3-pyridyl-4,4′,5,5′-tetraphenylbiimidazole, 2,2′-d1-3-thienyl-4,4′,5,5′-tetraphenylbiimidazole, 2,2′-di-o-tolyl-4,4′,5,5′-tetraphenylbiimidazole, 2,2′-di-p-tolyl-4,4′-d1-o-tolyl-5,5′-diphenylbiimidazole, 2,2′-di-2,4-xylyl-4,4′,5,5-tetraphenylbiimidazole, 2,2′,4,4′,5,5′-hexakis(p-benzylthiophenyl)biimidazole, 2,2′,4,4′,5,5′-hexa-1-naphthylbiimidazole, 2,2′,4,4′,5,5′-hexaphenylbiimidazole, 2,2′-bis(2-nitro-5-methoxyphenyl)-4,4′,5,5′-tetraphenylbiimidazole, 2,2′-bis(o-nitrophenyl)-4,4′,5,5′-tetrakis(m-methoxyphenyl)biimidazole and 2,2′-bis(2-chloro-5-sulfophenyl)-4,4′,5,5′-tetraphenyl biimidazole.

Semiconductor nanoparticles that can be used as multiphoton photosensitizers in the holographic composition include those that have at least one electronic excited state that is accessible by absorption (preferably, simultaneous absorption) of two or more photons. It is desirable for the nanoparticles to be substantially soluble (thus, substantially non-agglomerated) in the photoactive material. Suitable nanoparticles generally have an average diameter of about 1 nanometer (nm) to about 300 nm. Nanoparticles having a fairly narrow size distribution are desirable in order to avoid competitive one-photon absorption. The nanoparticles can comprise one or more semiconductor materials. Useful semiconductor materials include, for example, group II and group VI semiconductors. Suitable examples of group II and group VI semiconductors are ZnS, ZnSe, ZnTe, CdS, CdSe, CdTe, HgS, HgSe, HgTe, MgTe, or the like, or a combination comprising at least one of the foregoing group II semiconductor nanoparticle. Suitable examples of group III-V include GaN, GaP, GaAs, GaSb, InN, InP, InAs, InSb, AlAs, AlP, AlSb, AlS, or the like, or a combination comprising at least one of the foregoing group III-V semiconductor particles. Suitable examples of group IV semiconductors include Ge, Si, or the like, or a combination comprising at least one of the foregoing group IV semiconductor nanoparticles.

Useful semiconductor nanoparticles include nanocrystals called quantum dots, which preferably have radii less than or equal to the bulk exciton Bohr radius of the semiconductor and constitute a class of materials intermediate between molecular and bulk forms of matter. In quantum dots, quantum confinement of both electron and hole in all three dimensions leads to an increase in the effective band gap of the semiconductor with decreasing particle size. Consequently, both the absorption edge and the emission wavelength of the particles shift to higher energies as the particle size gets smaller. This effect can be used to adjust the effective oxidation and reduction potentials of the particle and to tune the particle's emission wavelengths to match the absorption bands of other components of the photosensitizer system.

Particularly desirable semiconductor nanoparticles comprise a “core” of one or more first semiconductor materials surrounded by a “shell” of a second semiconductor material (hereinafter, “core/shell” semiconductor nanoparticles). The surrounding shell material can be chosen to have an atomic spacing close to that of the core material. When enhanced luminescence is desired, the band gaps and band offsets of the core/shell pair can be chosen so that it is energetically favorable for both electron and hole to reside in the core. When enhanced probability of charge separation of the electron-hole pair is desired, the band gaps and band offsets of the core/shell pair can be chosen so that it is energetically favorable for the electron to reside in the shell and the hole to reside in the core, or vice versa.

In one embodiment, at least a portion of the surface of the nanoparticles is modified so as to aid in the compatibility and dispersibility or solubility of the nanoparticles in the reactive species. This surface modification can be effected by various different methods that are known in the art. In general, suitable surface treatment agents comprise at least one moiety that is selected to provide solubility in the photoactive material (a solubilizing or stabilizing moiety) and at least one moiety that has an affinity for the semiconductor surface (a linking moiety). Suitable linking moieties include those that comprise at least one electron pair that is available for interaction with the semiconductor surface (for example, moieties comprising oxygen, sulfur, nitrogen, or phosphorus). Examples of suitable surface treatment agents comprising such linking moieties include amines, thiols, phosphines, amine oxides, phosphine oxides, or the like. Such linking moieties attach to the semiconductor surface primarily through coordinate bonding of the lone electron pairs of the nitrogen, sulfur, oxygen, or phosphorus atom of the linking group. However, surface treatment agents comprising linking moieties that can attach to the surface of the nanoparticles through other types of chemical bonding (for example, covalent bonding or ionic bonding) or through physical interaction can also be used, as stated above.

As noted above, one-photon photosensitizers, two-photon and three-photon photosensitizers can be used to activate the photoactive material in the holographic composition. Examples of one-photon photosensitizers include free radical photosensitizers that generate a free radical source and cationic photosensitizers that generate an acid (including either protic or Lewis acids) when exposed to radiation having a wavelength in the ultraviolet or visible portion of the electromagnetic spectrum.

Examples of suitable free-radical photosensitizers include acetophenones, benzophenones, aryl glyoxalates, acylphosphine oxides, benzoin ethers, benzil ketals, thioxanthones, chloroalkyltriazines, bisimidazoles, triacylimidazoles, pyrylium compounds, sulfonium and iodonium salts, mercapto componds, quinones, azo compounds, organic peroxides, and mixtures thereof.

Examples of useful cationic photosensitizers include metallocene salts having an onium cation and a halogen-containing complex anion of a metal or metalloid, metallocene salts having an organometallic complex cation and a halogen-containing complex anion of a metal or metalloid, iodonium salts, sulfonium salts, or the like, or a combination comprising at least one of the foregoing cationic photosensitizers.

Other examples of one-photon photosensitizers are ketones, coumarin dyes (e.g., ketocoumarins), xanthene dyes, acridine dyes, thiazole dyes, thiazine dyes, oxazine dyes, azine dyes, aminoketone dyes, porphyrins, aromatic polycyclic hydrocarbons, p-substituted aminostyryl ketone compounds, aminotriaryl methanes, merocyanines, squarylium dyes, cyanine dyes, pyridinium dyes, or the like, or a combination comprising at least one of the foregoing one-photon photosensitizers.

One class of ketone photosensitizers comprises those represented by the following general structure (XXIX):
ACO(X)_{b}B (XXIX)
where X is CO or CR₁R₂, where R₁ and R₂ can be the same or different and can be hydrogen, alkyl, alkaryl, or aralkyl; b is zero; and A and B can be the same or different and can be substituted (having one or more non-interfering substituents) or unsubstituted aryl, alkyl, alkaryl, or aralkyl groups, or together A and B can form a cyclic structure that can be a substituted or unsubstituted alicyclic, aromatic, heteroaromatic, or fused aromatic ring.

Examples of suitable ketones of the above formula include monoketones (b=0) such as 2,2-, 4,4-, or 2,4-dihydroxybenzophenone, di-2-pyridyl ketone, di-2-furanyl ketone, di-2-thiophenyl ketone, benzoin, fluorenone, chalcone, Michler's ketone, 2-fluoro-9-fluorenone, 2-chlorothioxanthone, acetophenone, benzophenone, 1- or 2-acetonaphthone, 9-acetylanthracene, 2-, 3- or 9-acetylphenanthrene, 4-acetylbiphenyl, propiophenone, n-butyrophenone, valerophenone, 2-, 3- or 4-acetylpyridine, 3-acetylcoumarin, or the like, or a combination comprising at least one of the foregoing ketones. Examples of suitable diketones include aralkyldiketones such as anthraquinone, phenanthrenequinone, o-, m- and p-diacetylbenzene, 1,3-, 1,4-, 1,5-, 1,6-, 1,7- and 1,8-diacetylnaphthalene, 1,5-, 1,8- and 9,10-diacetylanthracene, or the like, or a combination comprising at least one of the foregoing diketones. Examples of suitable alpha-diketones (b=1 and x=CO) include 2,3-butanedione, 2,3-pentanedione, 2,3-hexanedione, 3,4-hexanedione, 2,3-heptanedione, 3,4-heptanedione, 2,3-octanedione, 4,5-octanedione, benzil, 2,2′-, 3 3′-, and 4,4′-dihydroxylbenzil, furyl, di-3,3′-indolylethanedione, 2,3-bornanedione (camphorquinone), biacetyl, 1,2-cyclohexanedione, 1,2-naphthaquinone, acenaphthaquinone, or the like, or a combination comprising at least one of the foregoing alpha-diketones.

Examples of suitable ketocoumarins and p-substituted aminostyryl ketone compounds include 3-(p-dimethylaminocinnamoyl)-7-dimethyl-aminocoumarin, 3-(p-dimethylaminocinnamoyl)-7-dimethyl-aminocoumarin, 3-(p-diethylaminocinnamoyl)-7-dimethyl-aminocoumarin, 3-(p-diethylaminocinnamoyl)-7-dimethyl-aminocoumarin, 9′-julolidine-4-piperidinoacetophenone, 9′-julolidine-4-piperidinoacetophenone, 9-(4-diethylaminocinnamoyl)-1,2,4,5-tetrahydro-3H,6H,10H[1]benzopyrano[6,7,8-i,j]quinolizine-10-one, 9-(4-diethylaminocinnamoyl)-1,2,4,5-tetrahydro-3H,6H,10H[1]benzopyrano[6,7,8-i,j]quinolizine-10-one, 9-(4-dicyanoethylaminocinnamoyl)-1,2,4,5-tetra-hydro-3H,6H,10H[1]benzopyrano[6,7,8-i,j]-quinolizine-10-one, 9-(4-dicyanoethylaminocinnamoyl)-1,2,4,5-tetra-hydro-3H,6H,10H[1]benzopyrano[6,7,8-i,j ]-quinolizine-10-one, 2,3-bis(9′-julolidine)cyclopentanone, 2,3-bis(9′-julolidine)cyclopentanone, 9-ethoxycarbonyl-1,2,4,5-tetrahydro-3H,6H,10H-[1]benzopyrano[6,7,8-i,j ]quinolizine-10-one, 9-ethoxycarbonyl-1,2,4,5-tetrahydro-3H,6H,10H-[1]benzopyrano[6,7,8-i,j ]quinolizine-10-one, 2-(4′-diethylaminobenzylidine)-1-indanone, 2-(4′-diethylaminobenzylidine)-1-indanone, 9-acetyl-1,2,4,5-tetrahydro-3H,6H,10H[1]benzo-pyrano[6,7,8-ij]quinolizine-10-one, 9-acetyl-1,2,4,5-tetrahydro-3H,6H,10H[1]benzopyrano[6,7,8-ij]quinolizine-10-one, 5,10-diethoxy-12,16,17-trichloroviolanthrene, and 5,10-diethoxy-12,16,17-trichloroviolanthrene, or the like, or a combination comprising at least one of the foregoing ketocoumarins and p-substituted aminostyryl ketone compounds.

Other examples of suitable one-photon photosensitizers include rose bengal (that is, 4,5,6,7-tetrachloro-2′,4′,5′,7′-tetraiodo fluorescein disodium salt, 3-methyl-2-[(1E,3E)-3-(3-methyl-1,3-benzothiazol-2(3H)-ylidene)prop-1-enyl]-1,3-benzothiazol-3-ium iodide, camphorquinone, glyoxal, biacetyl, 3,3,6,6-tetramethylcyclohexanedione, 3,3,7,7-tetramethyl-1,2-cycloheptanedione, 3,3,8,8-tetramethyl-1,2-cyclooctanedione, 3,3,18,18-tetramethyl-1,2-cyclooctadecanedione, dipivaloyl, benzil, furil, hydroxybenzil, 2,3-butanedione, 2,3-pentanedione, 2,3-hexanedione, 3,4-hexanedione, 2,3-heptanedione, 3,4-heptanedione, 2,3-octanedione, 4,5-octanedione, 1,2-cyclohexanedione, or the like, or a combination comprising at least one of the foregoing.

As noted above electron donor compounds can be used in the photosensitizer composition. Examples of suitable electron donor compounds include amines amides, ethers, ureas, sulfinic acids and their salts, salts of ferrocyanide, ascorbic acid and its salts, dithiocarbamic acid and its salts, salts of xanthates, salts of ethylene diamine tetraacetic acid, salts or the like, or a combination comprising at least one of the foregoing electron donors. The electron donor compound can be unsubstituted or can be substituted with one or more non-interfering substituents. Exemplary electron donor compounds contain an electron donor atom (such as a nitrogen, oxygen, phosphorus, or sulfur atom) and an abstractable hydrogen atom bonded to a carbon or silicon atom alpha to the electron donor atom.

Examples of suitable amine electron donor compounds include alkyl-, aryl-, alkaryl- and aralkyl-amines (e.g., methylamine, ethylamine, propylamine, butylamine, triethanolamine, amylamine, hexylamine, 2,4-dimethylaniline, 2,3-dimethylaniline, o-, m- and p-toluidine, benzylamine, aminopyridine, N,N′-dimethylethylenediamine, N,N′-diethylethylenediamine, N,N′-dibenzylethylenediamine, N,N′-diethyl-1,3-propanediamine, N,N′-diethyl-2-butene-1,4-diamine, N,N′-dimethyl-1,6-hexanediamine, piperazine, 4,4′-trimethylenedipiperidine, 4,4′-ethylenedipiperidine, p-N,N-dimethyl-aminophenethanol and p-N-dimethylaminobenzonitrile); aminoaldehydes (e.g., p-N,N-dimethylaminobenzaldehyde, p-N,N-diethylaminobenzaldehyde, 9-julolidine carboxaldehyde, and 4-morpholinobenzaldehyde); and aminosilanes (e.g., trimethylsilylmorpholine, trimethylsilylpiperidine, bis(dimethylamino) diphenylsilane, tris(dimethylamino)methylsilane, N,N-diethylaminotrimethylsilane, tris(dimethylamino)phenylsilane, tris(methylsilyl)amine, tris(dimethylsilyl)amine, bis(dimethylsilyl)amine, N,N-bis(dimethylsilyl)aniline, N-phenyl-N-dimethylsilylaniline, and N,N-dimethyl-N-dimethylsilylamine); or the like, or a combination comprising at least one of the foregoing amines.

Examples of suitable amide electron donor compounds include N,N-dimethylacetamide, N,N-diethylacetamide, N-methyl-N-phenylacetamide, hexamethylphosphoramide, hexaethylphosphoramide, hexapropylphosphoramide, trimorpholinophosphine oxide, tripiperidinophosphine oxide, or the like, or a combination comprising at least one of the foregoing amides.

Suitable electron acceptor photosensitizers for use in the holographic compositions include those that are capable of being photosensitized by accepting an electron from an electronic excited state of the one-photon photosensitizer or semiconductor nanoparticle, resulting in the formation of at least one free radical and/or acid. Such photosensitizers include iodonium salts (e.g., diaryliodonium salts), chloromethylated triazines (e.g., 2-methyl-4,6-bis(trichloromethyl)-s-triazine, 2,4,6-tris(trichloromethyl)-s-triazine, and 2-aryl-4,6-bis(trichloromethyl)-s-triazine), diazonium salts (e.g., phenyldiazonium salts optionally substituted with groups such as alkyl, alkoxy, halo, or nitro), sulfonium salts (for example, triarylsulfonium salts optionally substituted with alkyl or alkoxy groups, and optionally having 2,2′ oxy groups bridging adjacent aryl moieties), azinium salts (for example, an N-alkoxypyridinium salt), and triarylimidazolyl dimers (preferably, 2,4,5-triphenylimidazolyl dimers such as 2,2′,4,4′,5,5′-tetraphenyl-1,1′-biimidazole, or the like, or a combination comprising at least one of the foregoing electron.

Examples of suitable iodonium salt photosensitizers include diphenyliodonium tetrafluoroborate; di(4-methylphenyl)iodonium tetrafluoroborate; phenyl-4-methylphenyliodonium tetrafluoroborate; di(4-heptylphenyl)iodonium tetrafluoroborate; di(3-nitrophenyl)iodonium hexafluorophosphate; di(4-chlorophenyl)iodonium hexafluorophosphate; di(naphthyl)iodonium tetrafluoroborate; di(4-trifluoromethylphenyl)iodonium tetrafluoroborate; diphenyliodonium hexafluorophosphate; di(4-methylphenyl)iodonium hexafluorophosphate; diphenyliodonium hexafluoroarsenate; di(4-phenoxyphenyl)iodonium tetrafluoroborate; phenyl-2-thienyliodonium hexafluorophosphate; 3,5-dimethylpyrazolyl-4-phenyliodonium hexafluorophosphate; diphenyliodonium hexafluoroantimonate; 2,2′-diphenyliodonium tetrafluoroborate; di(2,4-dichlorophenyl)iodonium hexafluorophosphate; di(4-bromophenyl)iodonium hexafluorophosphate; di(4-methoxyphenyl)iodonium hexafluorophosphate; di(3-carboxyphenyl)iodonium hexafluorophosphate; di(3-methoxycarbonylphenyl)iodonium hexafluorophosphate; di(3-methoxysulfonylphenyl)iodonium hexafluorophosphate; di(4-acetamidophenyl)iodonium hexafluorophosphate; di(2-benzothienyl)iodonium hexafluorophosphate; diphenyliodonium hexafluoroantimonate; or the like; or a combination comprising at least one of the foregoing indonium salts.

Examples of suitable diazonium salts include 1-diazo-4-anilinobenzene, N-(4-diazo-2,4-dimethoxy phenyl)pyrrolidine, 1-diazo-2,4-diethoxy-4-morpholino benzene, 1-diazo-4-benzoyl amino-2,5-diethoxy benzene, 4-diazo-2,5-dibutoxy phenyl morpholind, 4-diazo-1-dimethyl aniline, 1-diazo-N,N-dimethylaniline, 1-diazo-4-N-methyl-N-hydroxyethyl aniline, or the like, or a combination comprising at least one of the foregoing salts.

The photosensitizer is used in an amount of about 0.01 to about 10 weight percent (wt %), based upon the total weight of the holographic composition. A preferred amount of the photosensitizer is about 5 wt %, based upon the total weight of the holographic composition.

The fixing of the stored data can be achieved by physical and/or chemical means. Physical means employ a thermal or electromagnetic radiation based stimulus. Chemical means generally employ a chemical agent termed a fixing agent to deactivate the photosensitizer. In one method of practicing the deactivation step, the thermal stimulus, the chemical stimulus or the electromagnetic radiation based stimulus can each be applied separately to enable the fixing agent to deactivate the photosensitizer. In another method of practicing the deactivation step, any two or all three of the aforementioned stimuli can be jointly applied to enable the fixing agent to deactivate the photosensitizer. In yet another method of practicing the deactivation step, a first stimulus can be used to trigger a second stimulus that results in the deactivation of the photosensitizer. For example, electromagnetic radiation based stimulus can give rise to radicals that can deactivate the photosensitizer.

When a thermal process is used to deactivate the photosensitizer, the temperature of the holographic composition or an article manufactured from the composition is raised until the photosensitizer sublimates, evaporates or decomposes into a non-reactive species. The sublimation, evaporation or decomposition of the photosensitizer in this manner promotes deactivation.

When a chemical stimulus is used for fixing, a fixing agent used in the composition is reacted with the photosensitizer to deactivate the photosensitizer. The fixing agent as defined herein is a reactant that is effective to deactivate the photosensitizer. It is also present in an amount effective to deactivate the photosensitizer. For example, when the photosensitizer is a photoactivatable oxidant, a reductant can be used as the fixing agent.

When electromagnetic radiation based stimulus is used to deactivate the photosensitizer, the irradiation is conducted at a wavelength effective to liberate radicals that can deactivate the photosensitizer. The wavelength effective to liberate the radicals is generally different from the wavelength used to write data to the holographic data storage media.

In another embodiment, in another method of practicing the deactivation step, the holographic compositions can be irradiated with electromagnetic radiation of several different wavelengths to deactivate the photosensitizer. For example, ultraviolet and the visible electromagnetic energy can be used simultaneously, or sequentially, in order to deactivate to photosensitizer. In such cases, visible electromagnetic energy is generally applied first. The fixing agent can directly react with the photosensitizer to deactivate the photosensitizer. Alternatively, the fixing agent can react with the photoactive material to liberate radicals, which can deactivate the photosensitizer. Deactivating the photosensitizer prevents any further color change in the photoactive material. In another embodiment, in yet another method of practicing the deactivation step, the holographic composition can be thermally heated while simultaneously or sequentially irradiating the composition with electromagnetic energy.

After deactivation, the background's resistance to change color on subsequent exposure to color inducing electromagnetic radiation depends in general on the intensity of the radiation and the duration of the exposure. Thus the degree of deactivation obtained in a holographic composition can be measured by exposure to a pre-selected dosage of ultraviolet imaging radiation that normally produces a given amount of color. The degree of deactivation achieved depends on a number of factors such as, for example, the intensity of the deactivating electromagnetic radiation, the fixing agent utilized, and the stimulus used to activate the fixing agent. The thus exposed material is “deactivated” or “fixed,” with the deactivated area serving as the background against which the colored (imaged) area is to be viewed.

The wavelengths at which writing and reading are accomplished by using actinic radiation of about 350 nanometers to about 1,100 nanometers. In one embodiment, the writing and reading are accomplished at a wavelength of about 400 to about 800 nanometers. In another embodiment, the writing and reading are accomplished at a wavelength of about 400 to about 550 nanometers. Exemplary wavelengths at which writing and reading are accomplished are about 405 nanometers and about 532 nanometers.

In one embodiment, in one method of manufacturing the holographic data storage media, the photoactive material, the photosensitizer and the optional fixing agent can be incorporated into the organic polymer in a mixing process to form a data storage composition. Following the mixing process, the data storage composition is injection molded into a holographic data storage media. Examples of molding can include injection molding, blow molding, compression molding, vacuum forming, or the like.

The mixing processes by which the photoactive material, the photosensitizer and the optional fixing agent can be incorporated into the organic polymer involves the use of shear force, extensional force, compressive force, ultrasonic energy, electromagnetic energy, thermal energy or combinations comprising at least one of the foregoing forces or forms of energy and is conducted in equipment wherein the aforementioned forces are exerted by a single screw, multiple screws, intermeshing co-rotating or counter rotating screws, non-intermeshing co-rotating or counter rotating screws, reciprocating screws, screws with pins, screws with screens, barrels with pins, rolls, rams, helical rotors, baffles, or combinations comprising at least one of the foregoing.

The mixing can be conducted in machines such as a single or multiple screw extruder, a Buss kneader, a Henschel, a helicone, an Eirich mixer, a Ross mixer, a Banbury, a roll mill, molding machines such as injection molding machines, vacuum forming machines, blow molding machine, or then like, or a combination comprising at least one of the foregoing machines.

After the molding of the data storage media the data can be stored onto the media by irradiating the media with electromagnetic energy having a first wavelength. The irradiation facilitates the activation of the photosensitizer thereby promoting a change in the color of the photoactive material and creating a hologram into which the data is encoded. In order to recover (read) the data without destroying or degrading it, the media is irradiated with electromagnetic energy having a second wavelength. As noted above the first and second wavelengths can be between 400 and 800 nm. In one embodiment, the first wavelength is not equal to the second wavelength. In another embodiment, the wavelength used to store the data is the same as the wavelength used to read the data. In such an embodiment, the first wavelength is equal to the second wavelength.

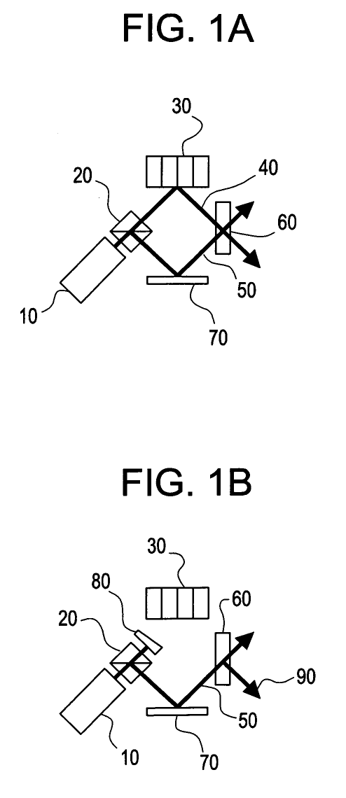

An example of a suitable holographic data storage process to create holographic storage media of the present disclosure is set forth in FIG. 1a. In this configuration, the output from a laser 10 is divided into two equal beams by beam splitter 20. One beam, the signal beam 40, is incident on a form of spatial light modulator (SLM) or deformable mirror device (DMD) 30, which imposes the data to be stored in signal beam 40. This device is composed of a number of pixels that can block or transmit the light based upon input electrical signals. Each pixel can represent a bit or a part of a bit (a single bit may consume more than one pixel of the SLM or DMD 30) of data to be stored. The output of SLM or DMD 30 is then incident on the storage medium 60. The second beam, the reference beam 50, is transmitted all the way to storage medium 60 by reflection off first mirror 70 with minimal distortion. The two beams are coincident on the same area of storage medium 60 at different angles. The net result is that the two beams create an interference pattern at their intersection in the storage medium 60. The interference pattern is a unique function of the data imparted to signal beam 40 by SLM or DMD 30. At least a portion of the photoactive monomer undergoes cyclization, which leads to a modification of the refractive index in the region exposed to the laser light and fixes the interference pattern, effectively creating a grating in the storage medium 60.

For reading the data, as depicted in FIG. 1b, the grating or pattern created in storage medium 60 is simply exposed to reference beam 50 in the absence of signal beam 40 by blocking signal beam 40 with a shutter 80 and the data is reconstructed in a recreated signal beam 90.

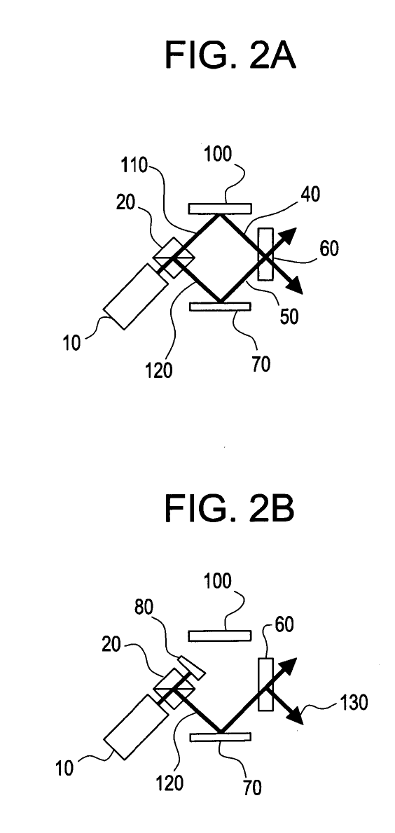

In order to test the characteristics of the material, a diffraction efficiency measurement can be used. A suitable system for these measurements is shown in FIG. 2a. This setup is very similar to the holographic storage setup; however, there is no SLM or DMD, but instead, a second mirror 100. The laser 10 is split into two beams 110 and 120 that are then interfered in storage medium 60 creating a plane wave grating. As depicted in FIG. 2b, one of the beams is then turned off or blocked with shutter 80 and the amount of light diffracted by the grating in storage medium 60 is measured. The diffraction efficiency is measured as the power in diffracted beam 130 versus the amount of total power incident on storage medium 60. More accurate measurements may also take into account losses in storage medium 60 resulting from reflections at its surfaces and/or absorption within its volume.

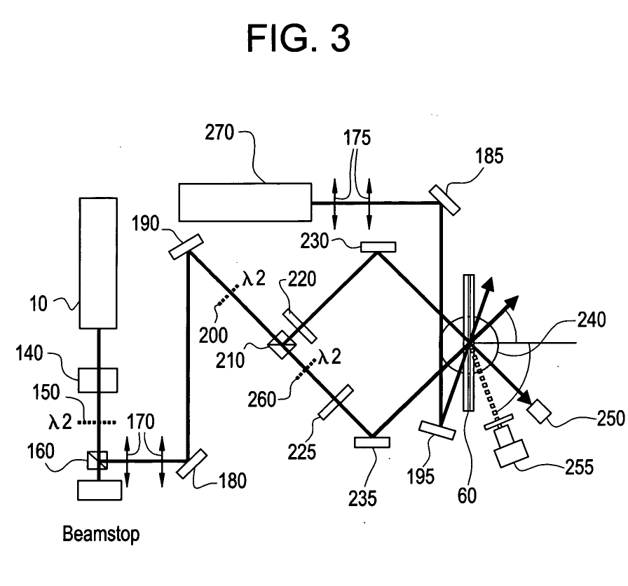

Alternatively, a holographic plane-wave characterization system may be used to test the characteristics of the medium, especially multiplexed holograms. Such a system can provide the M/# for a given sample, which is the metric used to characterize the ultimate dynamic range or information storage capacity of the sample as measured by the maximum number and efficiency of multiplexed holograms stored in the medium. A suitable system for these measurements is shown in FIG. 3. In this setup the output from first laser 10 is passed through a first shutter 140 for read/write control, a combination of a first half-wave plate 150, and a first polarizing beam splitter 160 for power control. The light is then passed through a first two-lens telescope 170 to adjust the beam size and reflected off first mirror 180 followed by second mirror 190 to transport the beam into the measurement area. The light is then passed through a second half-wave plate 200 and a second polarizing beam splitter 210 to split the beam in two and to control the power in each of the two beams. The beam reflected off of beam splitter 210 is then passed through a second shutter 220, which enables independent on/off control of the power in the first beam. The first beam is then reflected off of a third mirror 230 and is incident on medium 60, which is mounted on a rotation stage 240. The light from the first beam transmitted through medium 60 is collected into a first detector 250. The second beam is passed through a third half-wave plate 260 to rotate its polarization into the same direction as the first beam and then through a third shutter 225 to provide on/off control of the second beam. The second beam is then reflected off of fourth mirror 235 and is incident on medium 60. For measuring the in-situ dynamic change in the sample during exposure, a second laser 270 is passed through a second two-lens telescope 175, reflected off of fifth mirror 185 and then sixth mirror 195, and is then coincident on medium 60 at the same location as the first and second beams. The diffracted beam is then collected into second detector 255.

The holographic storage medium may be utilized in conjunction with a process whereby light of one wavelength from a laser is utilized to write the data into the holographic storage medium, while light of the same or a different wavelength is utilized to read the data. Thus, the wavelength employed for writing the data is a function of the specific photoactive material used. The holographic storage medium can be used for single bit type data storage. It can also be used for data storage when multiple holograms are stored in a given volume.

As one skilled in the art will appreciate, different molecules will have widely differing absorption profiles (broader, narrower, etc.). Thus, the wavelengths utilized for writing and reading the holographic storage media of the present disclosure will depend upon the light source, and the specific photoactive material.

The present disclosure is illustrated by the following non-limiting example.

### EXAMPLE

This example demonstrates the use of a carbon tetrabromide photosensitizer, which undergoes homolytic bond splitting to generate a bromine radical as shown in equation (I). This example also demonstrates the use of thermal stimulus as a mechanism for deactivation of the photosensitizer after color formation has occurred.

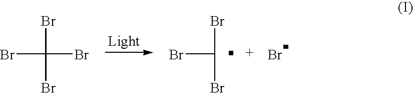

The bromine radical abstracts one electron from phenyl aniline and generates a radical cation from phenyl aniline as shown in equation (II).

The phenyl aniline undergoes a coupling reaction to generate a color as shown in equation (III)

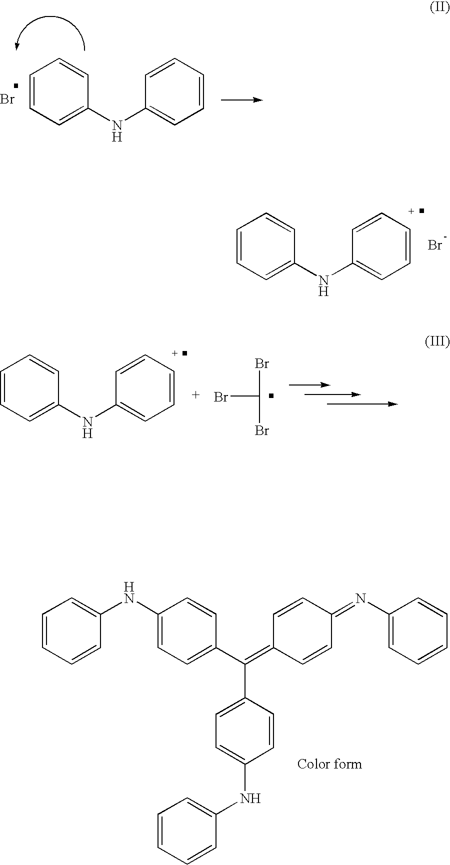

Following the change in color, the temperature is raised to effect a fixing of the color and the storage of data. The change in temperature results in a sublimation of CBr4 from the system. The fixing results in no additional color formation when the composition is irradiated with color inducing radiation.

### Example 2

This example demonstrates the use of electromagnetic radiation-based fixing. In this example a bisimidazole compound is used as the photosensitizer. When irradiate by light, it will generate an imidazole radical as can be seen in equation (IV) 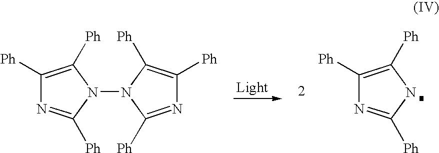
where Ph indicates a phenyl group. The imidazole radical will cause Crystal Violet to turn into colored form as shown in equation (V) below:

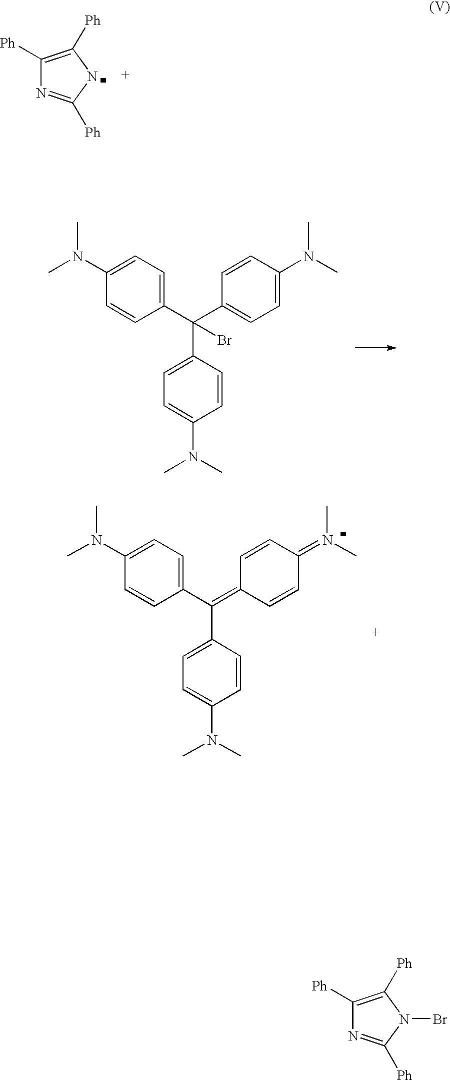

Fixing can be undertaken by irradiating the composition at a wavelength (different from the write wavelength) that is absorbed by pyrene-quinone, which generates hydroxyl-pyrene as per equation (VI)

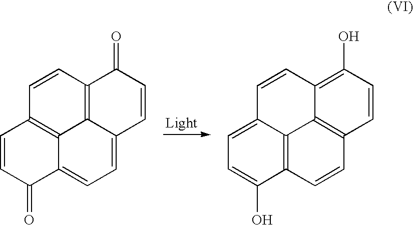

In the presence of hydoxy-pyrene, the imidazole radical generated during the writing process will be quenched and cannot cause any Crystal Violet to change into color form as shown in equation (VII)

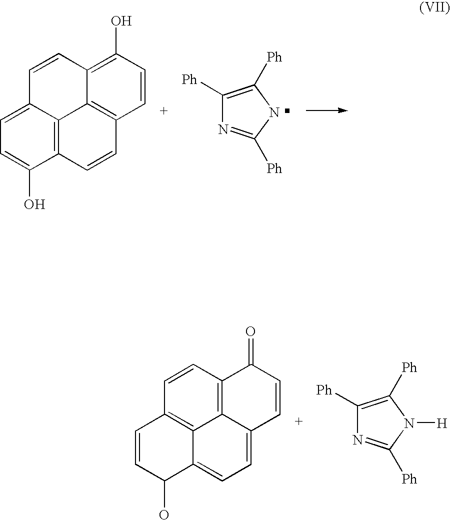

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention.

What is claimed is:

1. A method of manufacturing a data storage media comprising:
mixing a photoactive material, a photosensitizer and an organic binder material to form a holographic composition, wherein the photoactive material undergoes a change in color upon reaction with the photosensitizer; and
molding the holographic composition into holographic data storage media.

2. The method of claim 1, wherein the photoactive material comprises a dye that can undergo a color change upon reaction with the photosensitizer, wherein the photosensitizer is irradiated by actinic radiation having a wavelength of 350 to 1,100 nanometers.

3. The method of claim 1, wherein the photoactive material comprises anthranones and their derivatives; anthraquinones and their derivatives; croconines and their derivatives; monoazos, disazos, trisazos and their derivatives; benzimidazolones and their derivatives; diketo pyrrole pyrroles and their derivatives; dioxazines and their derivatives; diarylides and their derivatives; indanthrones and their derivatives; isoindolines and their derivatives; isoindolinones and their derivatives; naphtols and their derivatives; perinones and their derivatives; perylenes and their derivatives; ansanthrones and their derivatives; dibenzpyrenequinones and their derivatives; pyranthrones and their derivatives; bioranthorones and their derivatives; isobioranthorone and their derivatives; diphenylmethane, and triphenylmethane type pigments; cyanine and azomethine type pigments; indigoid type pigments; bisbenzoimidazole type pigments; azulenium salts; pyrylium salts; thiapyrylium salts; benzopyrylium salts; phthalocyanines and their derivatives, pryanthrones and their derivatives; quinacidones and their derivatives; quinophthalones and their derivatives; squaraines and their derivatives; squarilyiums and their derivatives; leuco dyes and their derivatives, deuterated leuco dyes and their derivatives; leuco-azine dyes; acridines; di-and tri-arylmethane, dyes; quinoneamines; o-nitro-substituted arylidene dyes, aryl nitrone dyes, or a combination comprising at least one of the foregoing.

4. The method of claim 1, wherein the photoactive material is a colorless leuco dye having the structure (XI) shown below: 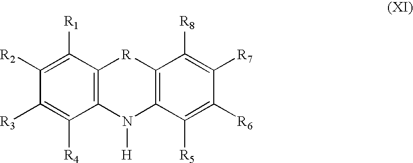
where R is sulfur or oxygen and R₁, R₂, R₃, R₄, R₅, R₆, R₇, and R₈ are the same or different and can independently be hydrogen, hydroxyl, alkyl, amine, —N(CH₃)₂; —N(C₂H₅)₂; or a combination comprising at least one of the foregoing substituents.

5. The method of claim 4, wherein the leuco dye has the following structures, 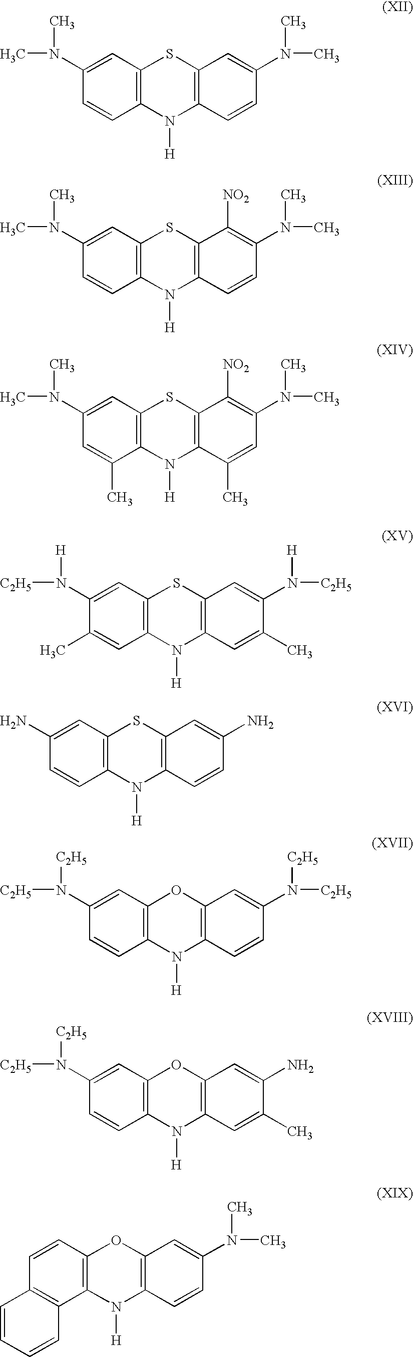 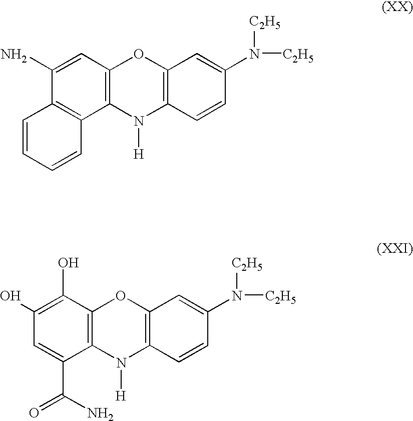
4,4′,4″-methylidynetris-(N,N-dimethylaniline)), p,p′-benzylidenebis-(N,N-dimethylaniline)), Leuco Atacryl Orange-LGM (Color Index Basic Orange 21) having the structure (XXVI) 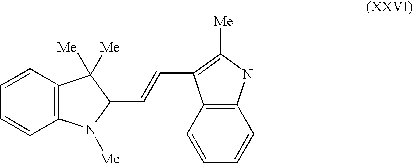
Leuco Atacryl Brilliant Red-4G having the structure (XXVII) 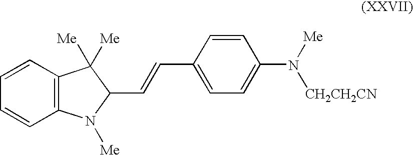
VII)
Leuco Atacryl Yellow-R having the structure (XXVIII) 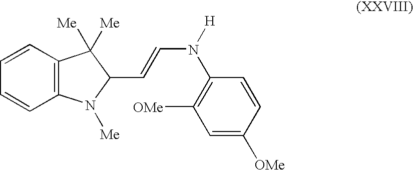
4,4′,4″-methylidynetris-(N,N-diethylaniline, 4,4′-methylidynebis-(N,N,-dimethylaniline)-4-(N-ethyl-1-napthalamine)), and 4,4′,4″-methylidynetris-aniline, or a combination comprising at least one of the foregoing leuco dyes.

6. The method of claim 4, wherein the deuterated leuco dyes are deuterated aminotriarylmethanes, deuterated aminoxanthenes, deuterated aminothioxanthenes, deuterated amino-9,10-dihydroacridines, deuterated aminophenoxazines, deuterated aminophenothiazines, deuterated aminodihydrophenazines, deuterated aminodiphenylmethanes, deuterated leuco indamines, deuterated aminohydrocinnamic acids (cyanoethanes, leuco methines), deuterated hydrazines, deuterated leuco indigoid dyes, deuterated amino-2,3-dihydroanthraquinones, deuterated tetrahalo-p,p′-biphenols, deuterated 2(p-hydroxyphenyl)-4,5-diphenylimidazoles, deuterated phenethylanilines, or a combination comprising at least one of the foregoing deuterated leuco dyes.

7. The method of claim 1, wherein the photoactive material is present in the holographic composition in an amount of 0.1 to about 50 weight percent, based on the total weight of the holographic composition.

8. The method of claim 1, wherein the photosensitizer facilitates a change the color of the photoactive material, when the holographic composition is irradiated.

9. The method of claim 8, wherein the change in color brings about a change in the refractive index.

10. The method of claim 1, wherein the photosensitizer is a photoactivatable oxidant, a one photon photosensitizer, a two photon photosensitizer, a three photon photosensitizer, a multiphoton photosensitizer, an acidic photosensitizer, a basic photosensitizer, a salt, a dye, a free radical photosensitizer, a cationic photosensitizer, or a combination comprising at least one of the foregoing photo sensitizers.

11. The method of claim 1, wherein the photosensitizer is a hexaarylbiimidazole compound, a semiconductor nanoparticle, a halogenated compound having a bond dissociation energy effective to produce a first halogen as a free radical of not less than about 40 kilocalories per mole, a sulfonyl halide, R—SO₂—X wherein R is a member of the group consisting of alkyl, alkenyl, cycloalkyl, aryl, alkaryl, or aralkyl and X is chlorine or bromine, a sulfenyl halide of the formula R′—S—X′ wherein R′ and X′ have the same meaning as R and X, a tetraaryl hydrazine, a benzothiazolyl disulfide, a polymethacrylaldehyde, an alkylidene 2,5-cyclohexadien-1-one, an azobenzyl, a nitroso, alkyl (T1), a peroxide, a haloamine, or a combination comprising at least one of the foregoing photosensitizer.

12. The method of claim 1, wherein the photosensitizer is an acetophenone, a benzophenone, an aryl glyoxalate, an acylphosphine oxide, a benzoin ether, a benzil ketal, a thioxanthone, a chloroalkyltriazine, a bisimidazole, a triacylimidazole, a pyrylium compound, a sulfonium salt, an iodonium salt, a mercapto compond, a quinone, an azo compound, an organic peroxide or a combination comprising at least one of the foregoing photosensitizers.

13. The method of claim 1, wherein the photosensitizer is present in an amount of 0.001 to 10 wt %, based on the total weight of the holographic composition.

14. The method of claim 1, further comprising irradiating the photosensitizer to change the refractive index of the photoactive material.

15. The method of claim 1, further comprising heating the article to a temperature at which the photosensitizer is sublimated, evaporated or decomposed.

16. The method of claim 1, further comprising heating the article to a temperature at which the photosensitizer ceases to activate the photoactive material.

17. The method of claim 1, wherein the holographic composition further comprises a fixing agent that deactivates the photosensitizer.

18. The method of claim 1, wherein the molding comprises injection molding.

19. The method of claim 1, wherein the organic binder material is an optically transparent organic polymer.

20. The method of claim 1, wherein the organic binder material is a thermoplastic polymer, a thermosetting polymer, or a combination of a thermoplastic polymer with a thermosetting polymer.

21. The method of claim 1, wherein the organic polymer is an oligomer, a polymer, a dendrimer, an ionomer, a copolymer, a block copolymer, a random copolymer, a graft copolymer, a star block copolymer or a combination comprising at least one of the foregoing organic polymers.

22. The method of claim 20, wherein the thermoplastic polymer is a polyacrylate, a polymethacrylate, a polyester, a polyolefin, a polycarbonate, a polystyrene, a polyamideimide, a polyarylate, a polyarylsulfone, a polyethersulfone, a polyphenylene sulfide, a polysulfone, a polyimide, a polyetherimide, a polyetherketone, a polyether etherketone, a polyether ketone ketone, a polysiloxane, a polyurethane, a polyether, a polyether amide, a polyether ester, or a combination comprising at least one of the foregoing thermoplastic polymers.

23. The method of claim 20, wherein the thermosetting polymer is an epoxy, a phenolic, a polysiloxane, a polyester, a polyurethane, a polyamide, a polyacrylate, a polymethacrylate, or a combination comprising at least one of the foregoing thermosetting polymers.

24. The method of claim 1, wherein the organic binder material is a precursor to a thermosetting polymer.

25. The method of claim 1, wherein the organic binder material is chemically attached to the photoactive material and/or the photosensitizer.

26. The method of claim 1, further comprising irradiating the molded holographic composition to form a hologram.

27. An article manufactured by the method of claim 1.

28. A method for recording information comprising:
irradiating an article that comprises a photoactive material; a photosensitizer and an organic polymer, wherein the irradiation is conducted with electromagnetic energy having a wavelength of about 350 to about 1,100 nanometers, wherein the photoactive material can undergo a change in color upon reaction with the photosensitizer; and
reacting the photoactive material to record data in holographic form.

29. The method of claim 28, wherein the photosensitizer activates the photoactive material promoting a change in the color of the photoactive material when the article is irradiated with electromagnetic radiation.

30. The method of claim 28, wherein the electromagnetic radiation has a wavelength of about 350 to about 1,100 nanometers.

31. The method of claim 28, further comprising deactivating the photosensitizer after a change in color has occurred in the photoactive material.

32. The method of claim 31, wherein the deactivation occurs upon thermally heating the article or upon irradiating the article with electromagnetic energy.

33. The method of claim 28, further comprising heating the article to a temperature at which the photosensitizer is sublimated, evaporated or decomposed.

34. The method of claim 28, further comprising heating the article to a temperature at which the photosensitizer ceases to activate the photoactive material.

35. The method of claim 28, further comprising fixing the photoactive material by using a fixing agent that reacts with the photosensitizer and deactivates the photosensitizer.

36. The method of claim 25, wherein the fixing agent deactivates the photosensitizer upon being irradiated by electromagnetic radiation.

37. A method for using a holographic data storage media comprising:
irradiating an article that comprises a photoactive material; a photosensitizer, a fixing agent and an organic binder material; wherein the photoactive material undergoes a change in color upon reaction with the photosensitizer; and wherein the irradiation is conducted with electromagnetic energy having a first wavelength and wherein the irradiating that is conducted at the first wavelength facilitates the storage of data;
reacting the photoactive material; and
irradiating the article at a second wavelength to read the data.

38. The method of claim 37, wherein the first wavelength is not the same as the second wavelength.

39. The method of claim 37, wherein the first wavelength is the same as the second wavelength.

40. The method of claim 37, wherein the photoactive material has the structure (XI) 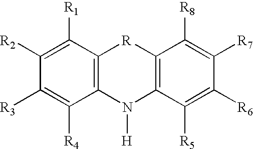
(XI) prior to irradiation and the structure (XXII) 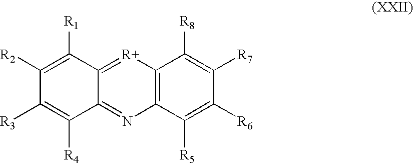
after irradiation; wherein in the structures (XI) and (XXII) R is sulfur or oxygen and R₁, R₂, R₃, R₄, R₅, R₆, R₇, and R₈ are the same or different and can independently be hydrogen, hydroxyl, alkyl, amine, —N(CH₃)₂; —N(C₂H₅)₂; or a combination comprising at least one of the foregoing substituents.

41. The method of claim 37, wherein the photoactive material has the structure (XXIII) 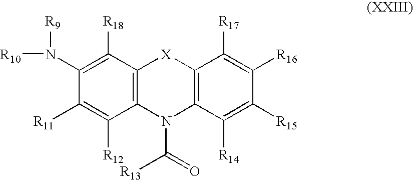
wherein X is selected from O, S, and —N—R₁₉; R₉ and R₁₀ are independently selected from H and alkyl groups of 1 to about 4 carbon atoms; R₁₁, R₁₂, R₁₄, and R₁₅ are independently selected from H and alkyl groups of 1 to about 4 carbon atoms; R₁₃ is selected from alkyl groups of 1 to about 16 carbon atoms, alkoxy groups of 1 to about 16 carbon atoms, and aryl groups of up to about 16 carbon atoms; R₁₆ is selected from —N(R₉)(R₁₀), H, alkyl groups of 1 to about 4 carbon atoms; R₁₇ and R₁₈ are independently selected from H and alkyl groups of 1 to about 4 carbon atoms; and R₁₉ is selected from alkyl groups of 1 to about 4 carbon atoms and aryl groups of up to about 11 carbon atoms.

42. An article comprising:
a holographic composition comprising a photoactive material; a photosensitizer, a fixing agent and an organic binder material; wherein the photoactive material can change color upon reaction with the photosensitizer; wherein the article is used for data storage.

43. The article of claim 42, wherein the photoactive material comprises a dye that can undergo a color change upon reaction with the photosensitizer, wherein the photosensitizer is irradiated by actinic radiation having a wavelength of 350 to 1,100 nanometers.

44. The article of claim 42, wherein the photoactive material comprises anthranones and their derivatives; anthraquinones and their derivatives; croconines and their derivatives; monoazos, disazos, trisazos and their derivatives; benzimidazolones and their derivatives; diketo pyrrole pyrroles and their derivatives; dioxazines and their derivatives; diarylides and their derivatives; indanthrones and their derivatives; isoindolines and their derivatives; isoindolinones and their derivatives; naphtols and their derivatives; perinones and their derivatives; perylenes and their derivatives; ansanthrones and their derivatives; dibenzpyrenequinones and their derivatives; pyranthrones and their derivatives; bioranthorones and their derivatives; isobioranthorone and their derivatives; diphenylmethane, and triphenylmethane type pigments; cyanine and azomethine type pigments; indigoid type pigments; bisbenzoimidazole type pigments; azulenium salts; pyrylium salts; thiapyrylium salts; benzopyrylium salts; phthalocyanines and their derivatives, pryanthrones and their derivatives; quinacidones and their derivatives; quinophthalones and their derivatives; squaraines and their derivatives; squarilylums and their derivatives; leuco dyes and their derivatives, deuterated leuco dyes and their derivatives; leuco-azine dyes; acridines; di-and tri-arylmethane, dyes; quinoneamines; o-nitro-substituted arylidene dyes, aryl nitrone dyes, or a combination comprising at least one of the foregoing.

45. The article of claim 44, wherein the leuco dye is a colorless leuco dye having the structure (XI) shown below: 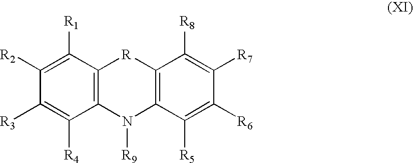
where R is sulfur or oxygen and R₁, R₂, R₃, R₄, R₅, R₆, R₇, and R₈ are the same or different and can independently be hydrogen, hydroxyl, alkyl, amine, —N(CH₃)₂; —N(C₂H₅)₂; or a combination comprising at least one of the foregoing substituents.

46. The article of claim 44, wherein the leuco dye has the following structures, 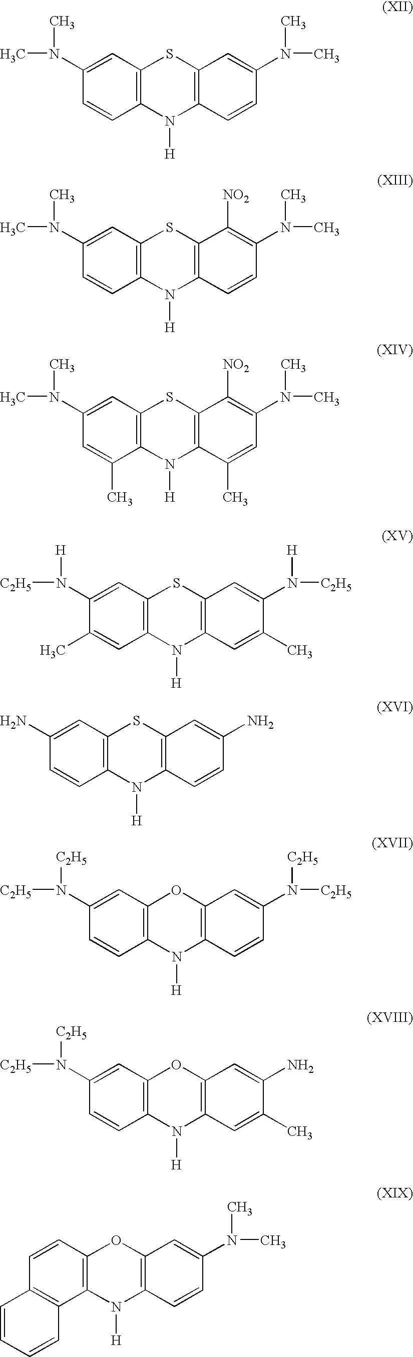 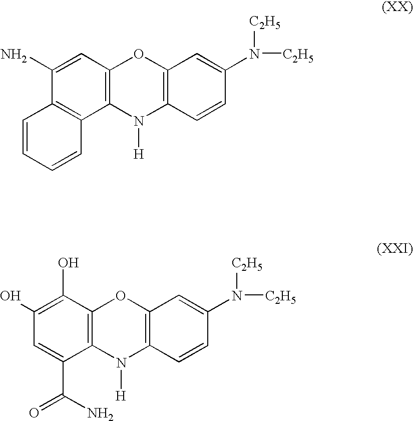
4,4′,4″-methylidynetris-(N,N-dimethylaniline)), p,p′-benzylidenebis-(N,N-dimethylaniline)), Leuco Atacryl Orange-LGM (Color Index Basic Orange 21) having the structure (XXVI) 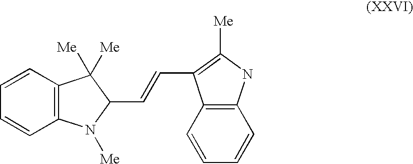
Leuco Atacryl Brilliant Red-4G having the structure (XXVII) 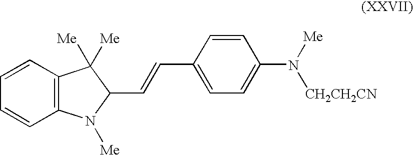
Leuco Atacryl Yellow-R having the structure (XXVIII) 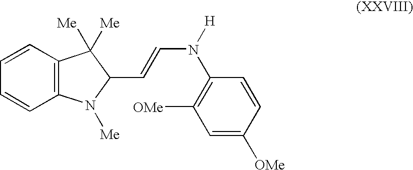
4,4′,4″-methylidynetris-(N,N-diethylaniline, 4,4′-methylidynebis-(N,N,-dimethylaniline)-4-(N-ethyl-1-napthalamine)), and 4,4′,4″-methylidynetris-aniline, or a combination comprising at least one of the foregoing leuco dyes.

47. The article of claim 44, wherein the deuterated leuco dyes are deuterated aminotriarylmethanes, deuterated aminoxanthenes, deuterated aminothioxanthenes, deuterated amino-9,10-dihydroacridines, deuterated aminophenoxazines, deuterated aminophenothiazines, deuterated aminodihydrophenazines, deuterated aminodiphenylmethanes, deuterated leuco indamines, deuterated aminohydrocinnamic acids (cyanoethanes, leuco methines), deuterated hydrazines, deuterated leuco indigoid dyes, deuterated amino-2,3-dihydroanthraquinones, deuterated tetrahalo-p,p′-biphenols, deuterated 2(p-hydroxyphenyl)-4,5-diphenylimidazoles, deuterated phenethylanilines, or a combination comprising at least one of the foregoing deuterated leuco dyes.

48. The article of claim 32, wherein the photoactive material has the structure (XXIII) 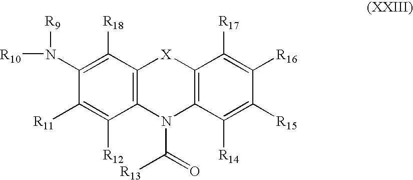
wherein X is selected from O, S, and —N—R₁₉; R₉ and R₁₀ are independently selected from H and alkyl groups of 1 to about 4 carbon atoms; R₁₁, R₁₂, R₁₄, and R₁₅ are independently selected from H and alkyl groups of 1 to about 4 carbon atoms; R₁₃ is selected from alkyl groups of 1 to about 16 carbon atoms, alkoxy groups of 1 to about 16 carbon atoms, and aryl groups of up to about 16 carbon atoms; R₁₆ is selected from —N(R₉)(R₁₀), H, alkyl groups of 1 to about 4 carbon atoms; R₁₇ and R₁₈ are independently selected from H and alkyl groups of 1 to about 4 carbon atoms; and R₁₉ is selected from alkyl groups of 1 to about 4 carbon atoms and aryl groups of up to about 11 carbon atoms.

49. The article of claim 42, wherein the photoactive material is present in the holographic composition in an amount of 0.1 to about 50 weight percent, based on the total weight of the holographic composition.

50. The article of claim 42, wherein the photosensitizer facilitates a change the color of the photoactive material, when the holographic composition is irradiated.

51. The article of claim 50, wherein the change in color brings about a change in the refractive index.

52. The article of claim 42, wherein the photosensitizer is a photoactivatable oxidant, a one photon photosensitizer, a two photon photosensitizer, a three photon photosensitizer, a multiphoton photosensitizer, an acidic photosensitizer, a basic photosensitizer, a salt, a dye, a free radical photosensitizer, a cationic photosensitizer, or a combination comprising at least one of the foregoing photosensitizers.

53. The article of claim 42, wherein the photosensitizer is a hexaarylbiimidazole compound, a semiconductor nanoparticle, a halogenated compound having a bond dissociation energy effective to produce a first halogen as a free radical of not less than about 40 kilocalories per mole, a sulfonyl halide, R—SO₂—X wherein R is a member of the group consisting of alkyl, alkenyl, cycloalkyl, aryl, alkaryl, or aralkyl and X is chlorine or bromine, a sulfenyl halide of the formula R′—S—X′ wherein R′ and X′ have the same meaning as R and X, a tetraaryl hydrazine, a benzothiazolyl disulfide, a polymethacrylaldehyde, an alkylidene 2,5-cyclohexadien-1-one, an azobenzyl, a nitroso, alkyl (T1), a peroxide, a haloamine, or a combination comprising at least one of the foregoing photosensitizer.

54. The article of claim 42, wherein the photosensitizer is an acetophenone, a benzophenone, an aryl glyoxalate, an acylphosphine oxide, a benzoin ether, a benzil ketal, a thioxanthone, a chloroalkyltriazine, a bisimidazole, a triacylimidazole, a pyrylium compound, a sulfonium salt, an iodonium salt, a mercapto compond, a quinone, an azo compound, an organic peroxide or a combination comprising at least one of the foregoing photosensitizers.

55. The article of claim 42, wherein the organic binder material is an optically transparent organic polymer.

56. The article of claim 42, wherein the organic binder material is a thermoplastic polymer, a thermosetting polymer, or a combination of a thermoplastic polymer with a thermosetting polymer.

57. The article of claim 42, wherein the organic binder material is a polymer precursor, an oligomer, a polymer, a dendrimer, an ionomer, a copolymer, a block copolymer, a random copolymer, a graft copolymer, a star block copolymer or a combination comprising at least one of the foregoing organic polymers.

58. The article of claim 57, wherein the thermoplastic polymer is a polyacrylate, a polymethacrylate, a polyester, a polyolefin, a polycarbonate, a polystyrene, a polyamideimide, a polyarylate, a polyarylsulfone, a polyethersulfone, a polyphenylene sulfide, a polysulfone, a polyimide, a polyetherimide, a polyetherketone, a polyether etherketone, a polyether ketone ketone, a polysiloxane, a polyurethane, a polyether, a polyether amide, a polyether ester, or a combination comprising at least one of the foregoing thermoplastic polymers.

59. The article of claim 57, wherein the thermosetting polymer is an epoxy, a phenolic, a polysiloxane, a polyester, a polyurethane, a polyamide, a polyacrylate, a polymethacrylate, or a combination comprising at least one of the foregoing thermosetting polymers.

60. The article of claim 42, wherein the photoactive material is covalently bonded to the organic binder material.

61. The article of claim 42, wherein a leuco dye or a deuterated leuco dye is covalently bonded to the organic binder material, wherein the organic binder material is a polymer precursor, an oligomer, a polymer, a dendrimer, an ionomer, a copolymer, a block copolymer, a random copolymer, a graft copolymer, a star block copolymer or a combination comprising at least one of the foregoing organic binder materials.

62. The article of claim 42, wherein the article is injection molded.

63. The article of claim 42, wherein the article is in the shape of a disc.
